(19) United States
(12) Patent Application Publication
(10) Pub. No.: US 2026/0231059 A1
(43) Pub. Date: Aug. 6, 2026

(54) METHODS, ARCHITECTURES, APPARATUSES AND SYSTEMS FOR ENABLING ENERGY EFFICIENT SSB SIGNALS AND PATTERNS

(71) Applicant: InterDigital Patent Holdings, Inc., Wilmington, DE (US)

(72) Inventors: Jaya Rao, Montreal (CA); Tao Deng, New York, NY (US); Faris Alfarhan, Montreal (CA); Paul Marinier, Brossard (CA); Umer Salim, Vallauris (FR); Janet Stern-Berkowitz, Little Neck, NY (US)

(21) Appl. No.: 19/044,008

(22) Filed: Feb. 3, 2025

(51) Int. Cl. H04W 56/00; H04W 72/231; H04W 74/0833

(52) U.S. Cl. CPC H04W 56/0015; H04W 72/231; H04W 74/0833

(57) ABSTRACT

Procedures, methods, architectures, apparatuses, systems, devices, and computer program products are disclosed and described. Based on configuration information (CI) received by a wireless transmit-receive unit (WTRU), the WTRU receives an SSB of the first type, and based on the CI and on information comprised in the SSB of the first type, an SSB of the second type. The WTRU may determine a search space (SS) for receiving PDCCH based on a PDCCH configuration indicated in the SSB of the second type. The WTRU may determine a periodicity of the SS for receiving PDCCH associated with a target SI. The WTRU may receive the PDCCH associated with the target SI in the SS according to the determined periodicity of the SS, wherein the target SI is received in a PDSCH accompanying the PDCCH; and transmit an indication to the network using resources indicated in the target SI.

### INCORPORATION BY REFERENCE

The following documents are incorporated herein by reference in their entirety: Third generation partnership project (3GPP) “Physical layer procedures for data”, 3GPP TS 38.214 V18.4.0(2024 -09); and 3GPP “Physical layer procedures for control”, 3GPP TS 38.213 V 18.4.0 (2024-09).

### BACKGROUND

The present disclosure is generally directed to the fields of energy efficiency in mobile networks, including, for example, to methods, architectures, apparatuses, systems related to enable energy-efficient signaling.

### SUMMARY

There are disclosed embodiments of methods, as described in the following and as claimed in the appended claims.

There are disclosed embodiments of a device, as described in the following and as claimed in the appended claims.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 shows information elements carried by physical broadcast channel (PBCH) and master information block (MIB), in terms of number of bits;

FIG. 3 shows an exemplary synchronization signal and PBCH block (SSB) beam sweeping within SSB burst;

FIG. 4 shows association between the periodicity of SSB-a and periodicity of SSB-b based on the scaling factor;

FIG. 5 shows the association between the SSB-a wide beams and SSB-b narrow beams;

FIG. 6 is a flow chart of a method according to an embodiment; and

FIG. 7 is a flow-chart of a method according to an embodiment.

### DETAILED DESCRIPTION

### Abbreviations and Acronyms

5G/6G Fifth/Sixth-Generation
AMF Access and Mobility Management Function
ARFCN Absolute Radio Frequency Channel Number
BCCH Broadcast Control Channel
BCH Broadcast Channel
BWP Bandwidth Part
BM Beam Management
CCE Control Channel Element
CD-SSB Cell-Defining SSB
CN Core Network
CORESET Control Resource Set
CQI Channel Quality Index
CRC Cyclic Redundancy Check
CRI CSI-RS resource indicator
CSI Channel State Information
CSI-RS CSI-Reference Signal
CSS Common Search Space
CONN Connected (RRC state)
DCI Downlink Control Information
DL Downlink
DMRS Demodulation Reference Signal
DRS Discovery Reference Signal
DTX/DRX Discontinuous Transmission/Reception
EPRE Energy Per Resource Element
FD Frequency Division (duplexing)
FR1/FR2 Frequency Band 1/2
GSCN Global Synchronization Channel Number
IAB Integrated Access and Backhaul
IDLE Idle (RRC state)
LP-SS Low-Power Synchronization Signal
MAC CE Media Access Control-Control Element
NCD-SSB Non-Cell-Defining SSB
MIB Master Information Block
Msg Message
MSI Minimum System Information
NEF Network Exposure Function
NES Network Energy Savings
NR New Radio
NTN Non-Terrestrial Network
NW Network
OD On-Demand
OFDM Orthogonal Frequency Division Multiplexing
PBCH Physical Broadcast Channel
PCF Policy Control Function
PCI Physical Cell Identifier
PDCCH Physical Downlink Control Channel
PDSCH Physical Downlink Shared Channel
PMI Precoding Matrix Index
PRACH Physical Random Access Channel
PRB Physical Resource Block
PSD Power Spectral Density
PSS Primary Synchronization Signal
PTRS Phase Tracking Reference Signal
PUCCH Physical Uplink Control Channel
PUSCH Physical Uplink Shared Channel
QCL Quasi-Colocation
QPSK Quadrature Phase Shift Keying
RA Random Access
RACH Random Access Channel
RI Rank Indicator
RIS Reconfigurable Intelligent (meta) Surface
RLM Radio Link Monitoring
RNTI Radio Network Temporary Identifier
RRC Radio Resource Control
RRM Radio Resource Management
RS Reference Signal
RSRP Reference Signal Received Power
RSRQ Reference Signal Received Quality
SFN System Frame Number
SI System Information
SIB System Information Block
SINR Signal Interference and Noise-Ratio
SMF Session Management Function
SpCell Serving Primary Cell
SRI Scheduling Request Indicator
SRS Sounding Reference Signal
SS Search Space
SSB Synchronization Signal Block
SSBRI SS/PBCH Block Resource Indicator
SSS Secondary Synchronization Signal
T/F Tile and/or Frequency
TCI Transmission Configuration Indicator
TD Time Division (duplexing)
TRP Transmission-Reception Point
TRS Tracking Reference Signal
UCI Uplink Control Information
UE User Equipment
UL Uplink
WTRU Wireless Transmit-Receive Unit
WUS Wake-Up Signal

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

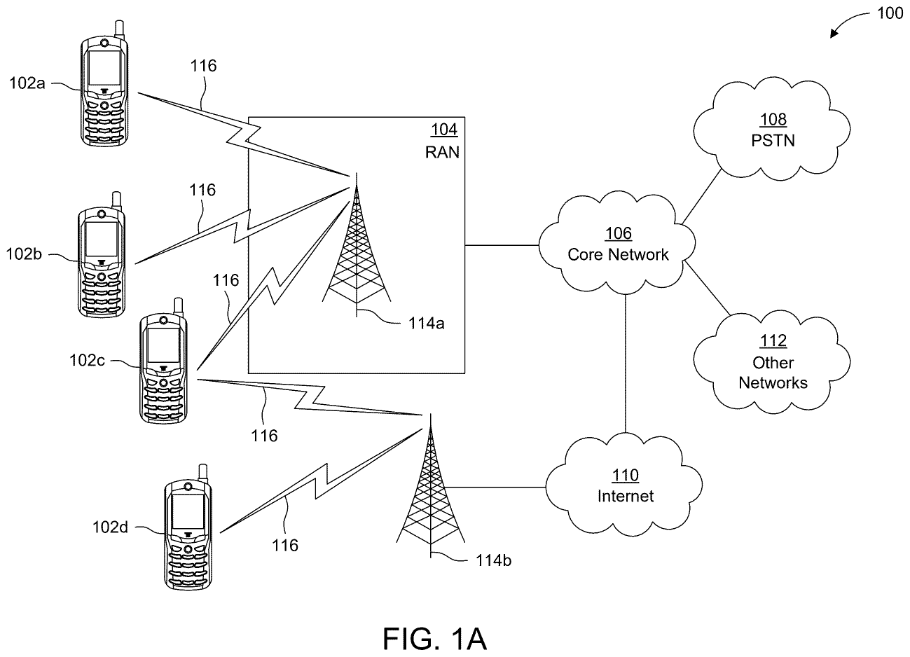

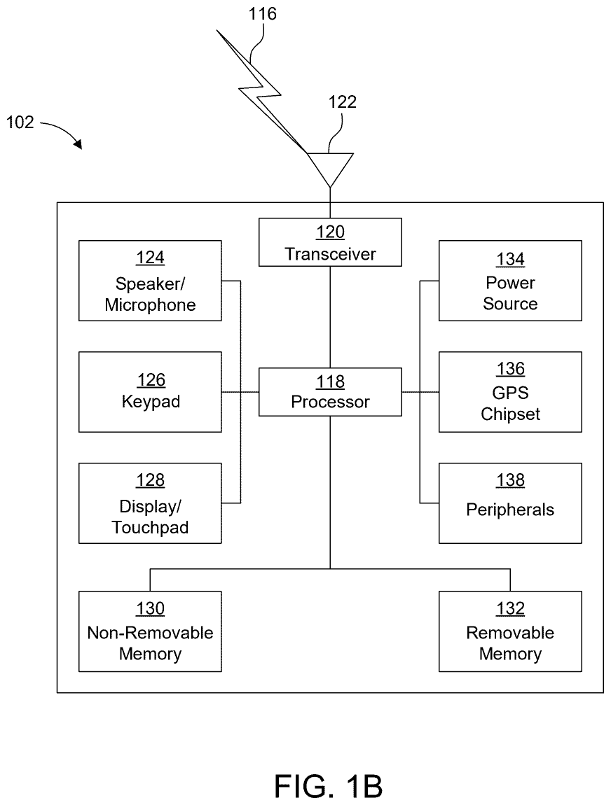

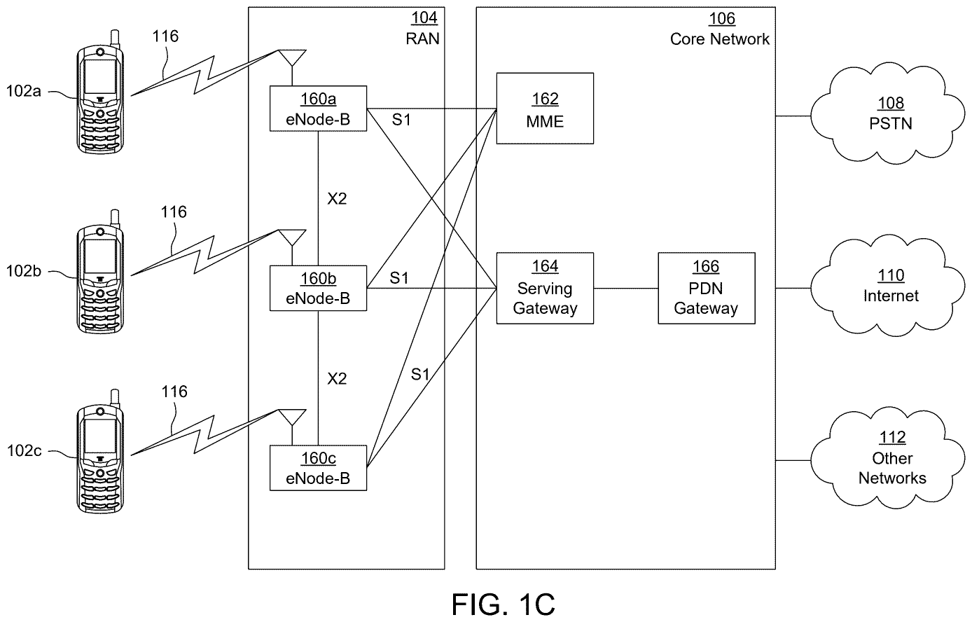

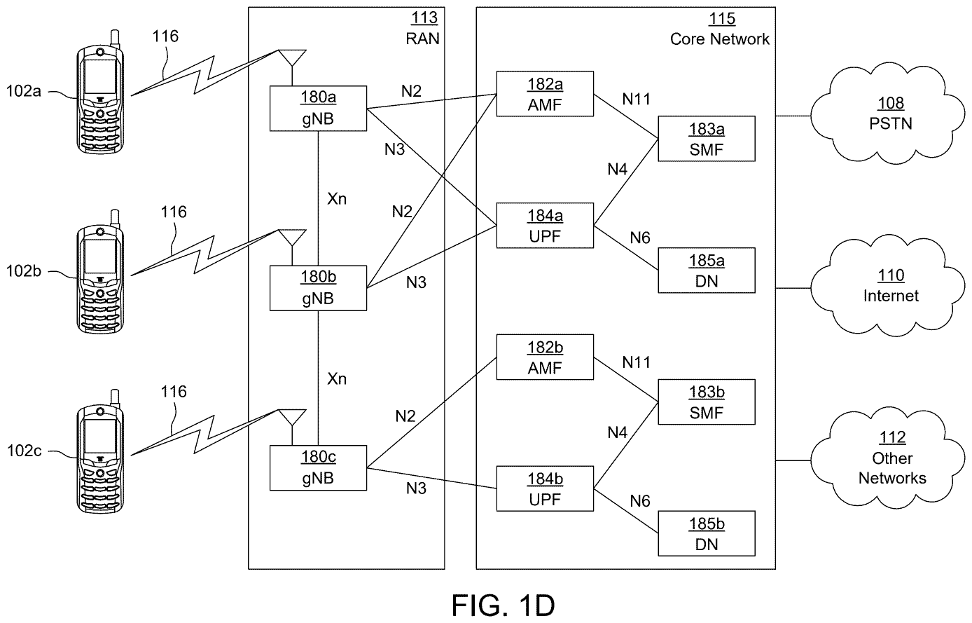

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IOT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114 b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Current standards enable the network to minimize its energy consumption due to transmissions and receptions. Such network energy savings (NES) capabilities include performing adaptations in multiple domains including in spatial domain (e.g. power off subsets of antenna ports, elements or panels), time domain (e.g. apply cell DTX/DRX or apply long periodicity for SSB transmissions), frequency domain (e.g. disable certain carriers or BWPs) or power domain (e.g. apply lower power offset values).

While the NES enhancements supported in R18 and R19 were specified with the assumption that the NW is lightly or moderately loaded in terms of achievable throughput by the UEs in cells, future releases or generations are expected to support more advanced capabilities and features for NES even in high load scenarios. It is essential to minimize the transmission of always-on signals/channels such as SSBs. It is also important to enable more energy efficient designs for the SSBs such that they may be made to be more purpose-specific for greater energy savings and rather than the one-size-fits-all designs that are used in legacy networks.

In NR, SSBs are used to support both IDLE mode (sync, initial access, paging, RA) and CONN mode (e.g. measurements, QCL source, RLM, BM) functions. This requires dense and frequent SSB transmission with short periodicity (20 ms) and across multiple frequency locations.

A synchronization signal block (SSB) may include one or more sync signals and/or a one or more physical broadcast channels (PBCH). Each sync signal and each PBCH may occupy one or more symbols.

A typical periodicity for an SSB (e.g., in 5G) may be, for example, 20 ms.

Using longer periodicity (>=160 ms) for SSBs (e.g., in 6G) can enable high network energy savings (NES) (e.g. 77%). However, the expected increase in latency and UE processing during cell search and initial access (e.g. increase 20 ms to 160 ms) may be unacceptable.

It may be desirable to minimize the impact on UE complexity and latency (e.g. during cell search) without impacting NES gains with longer periodicity SSBs. If the SSBs are transmitted in different time/frequency locations, it may be desirable to minimize/avoid the need for blind search of all possible SSB candidate locations. It may be desirable to minimize the resources/overhead for the SSBs (e.g., 6G/new SSBs) (e.g. during cell search).

SSBs transmitted by a cell (e.g. operating in NES mode) may include one or more the following (e.g. in 6G):

According to an embodiment, there is defined a first type of SSB, e.g., termed SSB-a. In terms of signals (signalization), the first type of SSB may comprise light sync signals (e.g. one or two sync signals that may use limited sequence length and/or resources) and a first PBCH type, which may be referred to herein as a light PBCH (e.g. contains small payload). The periodicity of SSB-a may be shorter relative to the periodicity of SSB-b (e.g. periodicity of SSB-a may be 20 ms).

According to an embodiment, there is defined a second type of SSB, e.g., termed SSB-b. In terms of signals, SSB-B may carry PSS/SSS, a second PBCH type which may contain a larger PBCH payload and may include one or more of MIB, SFN information, and other timing info. The periodicity of the SSB-b is longer relative to the periodicity of SSB-a (e.g. periodicity of SSB-b may be >=160ms).

Concerning WTRU configurations of SSB-a and SSB-b, a WTRU (e.g. in IDLE mode) may be predefined with parameters of (e.g., possible) SSB-a and SSB-b configurations and information on how SSB-a and SSB-b are associated. A WTRU (e.g. in CONNECTED mode or “CONN”) may be configured with the parameters of SSB-a and SSB configurations and association information.

Within the context of the problem posed, a WTRU is expected to determine the time/frequency/spatial locations of SSB-b signals/beams (e.g. for accessing MIB/SI, cell related info, RACH config for initial access) with low latency. This considers NES cell that transmits 6G SSBs (SSB-a and SSB-b) according to embodiments, while enabling WTRU idle mode functions (e.g. camping, cell (re)selection, initial access) when under the coverage of NES cells, and while enabling connected mode functions (e.g. L1/L3 measurements, radio link monitoring) when under the coverage of NES cells.

The following terminology is used and can be assumed throughout this disclosure.

Synchronization Signal Block or SS/PBCH block: may include at least one of the following: synchronization signals such as PSS (Primary Synchronization Signal) and SSS (Secondary Synchronization Signal), Physical Broadcast Channel PBCH (Data), Master information block (MIB) and PBCH (DMRS). The SSBs may be transmitted by the NW node (e.g. base station, TRP, relay node, RIS unit) in different directions as beams. The number of SSB beams in an SSB burst set, which may be transmitted periodically within an interval (e.g. 5ms) may depend on the carrier frequency. For example, an SSB burst may contain 4 SSBs for FR1 (<3 GHZ), 8 SSBs for FR1 (3 to 6 GHZ) and 64 SSBs for FR2. Certain SSBs may be transmitted as on-demand SSBs (OD-SSBs), which may possibly consist of a subset of SSBs in a burst. Such OD-SSBs may be transmitted aperiodically, semi-persistently, or periodically with certain periodicity. The transmission of such OD-SSBs may be triggered by the NW node or WTRU (e.g. via transmission of an UL WUS). Some SSBs may include slim/lean SSBs, which may comprise of PSS only, PSS and SSS-only, PBCH or a subset of MIB-only, for example.

CSI-RS: stands for channel state information reference signal, which may include at least one of the following: CSI-RS resource set (ID), CSI-RS resource (ID/index), resource mapping, power control offset values (e.g. with respect to PDSCH, SSB), scrambling ID, periodicity, offset and QCL info. CSI-RS may be transmitted in DL by the NW node as CSI-RS beams, via different resource types including periodic, semi-persistent and aperiodic.

CSI: stands for channel state information, which may include at least one of the following: channel quality index (CQI), rank indicator (RI), precoding matrix index (PMI), an L1 channel measurement (e.g. RSRP such as L1-RSRP, or SINR), CSI-RS resource indicator (CRI), SS/PBCH block resource indicator (SSBRI), layer indicator (LI) and/or any other measurement quantity measured by the WTRU from the configured CSI-RS or SS/PBCH (SSB) block.

Property of scheduling information: e.g., an uplink grant or a downlink assignment, may consist of at least one of the following: a frequency allocation; an aspect of time allocation, such as time instance or/and a time duration; a priority; a modulation and coding scheme; a transport block size; a number of spatial layers; a number of transport blocks to be carried; a TCI state or SRI; a number of repetitions; whether the grant is a configured grant type 1 (i.e., WTRU immediately using the configured UL resources after receiving the configuration information), type 2 (i.e., WTRU waiting until an explicit MAC CE indication before using the configured UL resources) or a dynamic grant.

Indication by DCI, or an indication: may consist of at least one of the following: an explicit indication by a DCI field or by RNTI used to mask CRC of the PDCCH. An implicit indication by a property such as DCI format, DCI size, Coreset or search space, aggregation level, identity of first control channel resource (e.g., index of first CCE) for a DCI, where the mapping between the property and the value may be signaled by RRC or MAC. an explicit indication by a DL MAC CE.

Network: throughout embodiments described herein, the network may include any of a base station (e.g. gNB, TRP, RAN node, access node, NTN node, IAB node, RIS unit/node), core network function (e.g. AMF, SMF, PCF, NEF) and application function (e.g. edge server function, remote server function), for example. NES cells may refer to any of the network nodes that may be operating in an NES state/mode, including any of time, frequency, spatial and/or power domain adaptation modes.

NES adaptations: throughout embodiments described herein, NES adaptations may include any of the adaptations at NW in the spatial domain (e.g. power off subsets of antenna ports, elements or panels), time domain (e.g. (de)activation of cell DTX/DRX, apply long periodicity or sparse transmissions of common signals/channels), frequency domain (e.g. disable certain carriers or BWPs) or power domain (e.g. apply lower power offset values).

Notation: “a” and “an” and similar phrases are to be interpreted as “one or more” and “at least one”. Similarly, any term which ends with the suffix “(s)” is to be interpreted as “one or more” and “at least one”. The term “may” is to be interpreted as “may, for example”. A symbol “/” (e.g., forward slash) may be used herein to represent “and/or”, where for example, “A/B” may imply “A and/or B”.

Synchronization Signals and Procedures in 5G NR Downlink Synchronization is the process in which WTRU detect the radio frame boundary (i.e., the exact timing when a radio frame starts) and OFDM symbol boundary (i.e., the exact timing when an OFDM symbol starts). This process is done by detecting and analyzing synchronization signal Block, termed as SSB.

Synchronization Signal and PBCH block A Synchronization Signal and PBCH block (SSB) consists of primary and secondary synchronization signals (PSS, SSS), each occupying 1 symbol and 127 subcarriers, and PBCH spanning across 3 OFDM symbols and 240 subcarriers, but on one symbol leaving an unused part in the middle for SSS as show in the figure below. The possible time locations of SSBs within a half-frame are determined by sub-carrier spacing and the periodicity of the half-frames where SSBs are transmitted is configured by the network. During a half-frame, different SSBs may be transmitted in different spatial directions (i.e. using different beams, spanning the coverage area of a cell).

Within the frequency span of a carrier, multiple SSBs can be transmitted. The PCIs of SSBs transmitted in different frequency locations do not have to be unique, i.e. different SSBs in the frequency domain can have different PCIs. However, when an SSB is associated with an RMSI, the SSB is referred to as a Cell-Defining SSB (CD-SSB). An SpCell is always associated to a CD-SSB located on the synchronization raster.

Polar coding is used for PBCH. The WTRU may assume a band-specific sub-carrier spacing for the SSB unless a network has configured the WTRU to assume a different sub-carrier spacing. PBCH symbols carry its own frequency multiplexed DMRS. QPSK modulation is used for PBCH.

### Cell Search

Cell search is the procedure by which a WTRU acquires time and frequency synchronization with a cell and detects the Cell ID of that cell. NR cell search is based on the primary and secondary synchronization signals, and PBCH DMRS, located on the synchronization raster.

### System Information

System Information (SI) is divided into the master information block (MIB) and a number of system information blocks (SIBs) where:
the MIB is always transmitted on the BCH with a periodicity of 80 ms and repetitions made within 80 ms (TS 38.212) and it includes parameters that are needed to acquire SIB1 from the cell;
the SIB1 is transmitted on the DL-SCH with a periodicity of 160 ms and variable transmission repetition periodicity within 160 ms as specified in TS 38.213. The default transmission repetition periodicity of SIB1 is 20 ms but the actual transmission repetition periodicity is up to network implementation;

MIB and SIB1 make up the minimum system information (MSI) required to operate on a cell.

The Master Information Block (MIB) on PBCH provides the WTRU with parameters (e.g. CORESET#0 configuration) for monitoring of PDCCH for scheduling PDSCH that carries the System Information Block 1 (SIB1). PBCH may also indicate that there is no associated SIB1, in which case the WTRU may be pointed to another frequency from where to search for an SSB that is associated with a SIB1 as well as a frequency range where the WTRU may assume no SSB associated with SIB1 is present. The indicated frequency range is confined within a contiguous spectrum allocation of the same operator in which SSB is detected.

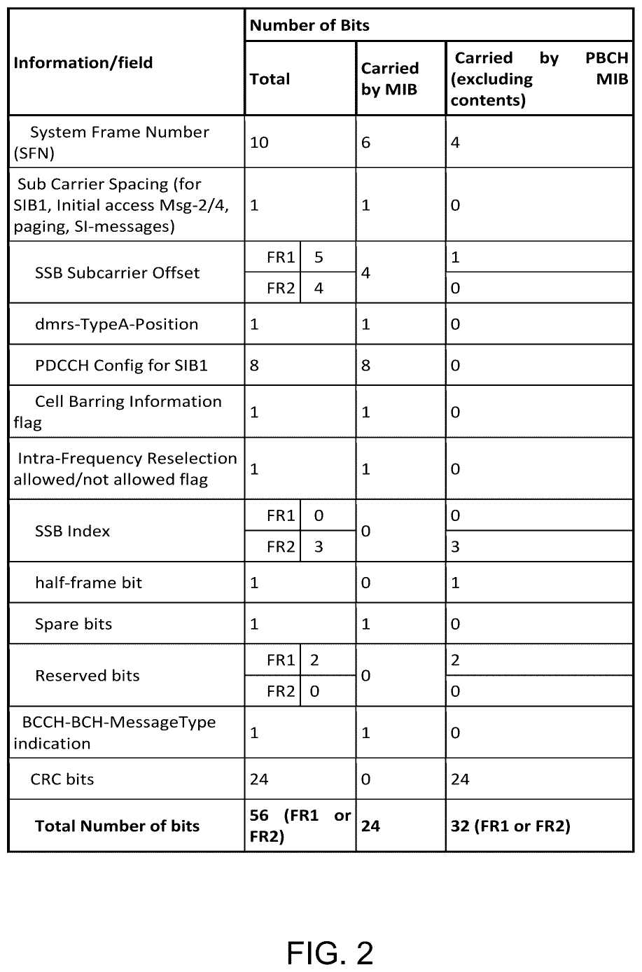

FIG. 2 shows the information elements carried by PBCH and MIB, in terms of number of bits.

### SSB Indexing and SSB Burst

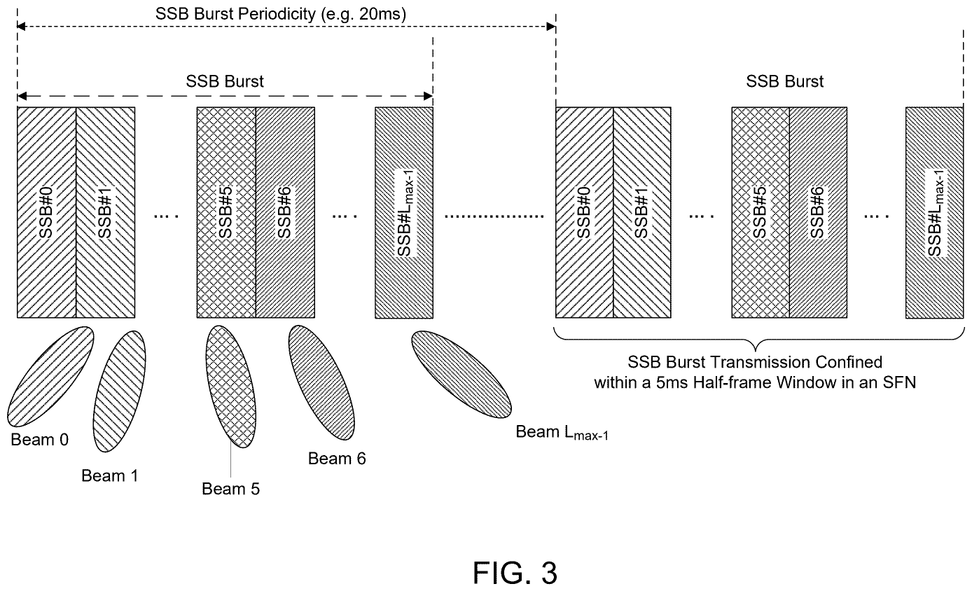

Each SSB within an SSB burst set (i.e., all of the SSBs within the 5 ms period of the SSB transmission) is assigned with a unique number starting from 0 and increasing by 1. This number resets to 0 in the next SSB burst set (i.e., next 5 ms span after SSB transmission cycle (e.g., after the default cycle of 20 ms). This unique number (i.e., SSB Index) is informed to the WTRU via PBCH DMRS and via PBCH payload. The candidate SSBs in a half frame are indexed in an ascending order in time from 0 to L-1. A WTRU shall determine the 2 LSB bits, for L=4, or the 3 LSB bits, for L>4, of a SSB index per half frame from a one-to-one mapping with an index of the DMRS sequence transmitted in the PBCH. For L=64, the WTRU shall determine the 3 MSB bits of the SS/PBCH block index per half frame by PBCH payload bits. FIG. 3 shows an SSB burst with a periodicity of 20 ms.

### Common Search Space

Upon detection of a SSB, the WTRU determines from MIB that a CORESET for Type0-PDCCH common search space (CSS) set is present if the SSB subcarrier offset (k_{SSB})<24 for FR1 or if k_{SSB}<12 for FR2. The WTRU determines from MIB that a CORESET for Type0-PDCCH CSS set is not present if k_{SSB>}23 for FR1 or if k_{SSB}>11 for FR2; the CORESET for Type0-PDCCH CSS set may be provided by PDCCH-Config PDCCH-Config in the MIB is indicated by 8 bits, where 4 LSB bits indicate the CORESET multiplexing pattern corresponding to search space (SS) 0 and the 4 MSB bits indicate the CORESET 0.

For SSB and CORESET multiplexing pattern 1, SIB1 repetition transmission period is 20 ms. For SSB and CORESET multiplexing pattern 2/3, SIB1 transmission repetition period is the same as the SSB period (TS 38.213). SIB1 includes information regarding the availability and scheduling (e.g., mapping of SIBs to SI message, periodicity, SI-window size) of other SIBs with an indication whether one or more SIBs are only provided on demand and, in that case, the configuration needed by the WTRU to perform the SI request. SIB1 is cell-specific SIB.

### Example Beam Definition

A WTRU may transmit or receive a physical channel or reference signal according to at least one spatial domain filter. The term “beam” may be used to refer to a spatial domain filter. The WTRU may transmit a physical channel or signal (e.g. PUCCH, PUSCH, SRS) using the same spatial domain filter as the spatial domain filter used for receiving an RS (such as CSI-RS) or a SS block. The WTRU transmission may be referred to as “target”, and the received RS or SS block may be referred to as “reference” or “source”. In such case, the WTRU may be said to transmit the target physical channel or signal according to a spatial relation with a reference to such RS or SS block.

The WTRU may transmit a first physical channel or signal according to the same spatial domain filter as the spatial domain filter used for transmitting a second physical channel or signal. The first and second transmissions may be referred to as “target” and “reference” (or “source”), respectively. In such case, the WTRU may be said to transmit the first (target) physical channel or signal according to a spatial relation with a reference to the second (reference) physical channel or signal. A spatial relation may be implicit, configured by RRC or signaled by MAC CE or DCI. For example, a WTRU may implicitly transmit PUSCH and DM-RS of PUSCH according to the same spatial domain filter as an SRS indicated by an SRI indicated in DCI or configured by RRC. In another example, a spatial relation may be configured by RRC for an SRS resource indicator (SRI) or signaled by MAC CE for a PUCCH. Such spatial relation may also be referred to as a “beam indication”.

The WTRU may receive a first (target) downlink channel or signal according to the same spatial domain filter or spatial reception parameter as a second (reference) downlink channel or signal. For example, such association may exist between a physical channel such as PDCCH or PDSCH and its respective DM-RS. At least when the first and second signals are reference signals, such association may exist when the WTRU is configured with a quasi-colocation (QCL) assumption type D between corresponding antenna ports. Such association may be configured as a TCI (transmission configuration indicator) state. A WTRU may be indicated an association between a CSI-RS or SS block and a DM-RS by an index to a set of TCI states configured by RRC and/or signaled by MAC CE. Such indication may also be referred to as a “beam indication”.

Herein, an SSB may refer to one or more SSB beam (spatial relation) within a collection of SSBs (SSB burst). An SSB may refer to a beam-and vice-versa-or a CSI-RS resource related to the beam. SSB, SSBs, and/or SSB burst may loosely refer to one or more beams transmitted from a TRP or a NW node.

Throughout the embodiments described in this disclosure, the terms “RS”, “RS beams”, “SSB” and “SSB beams” may be used interchangeably. Also, the terms SSB-a, sync signals, type-1 SSBs may be used interchangeably. Also, the terms SSB-b, full SSBs, type-2 SSBs may be used interchangeably. Also, the terms “RS config, “RS beam config”, “NES-RS config”, “SSB pattern” and “SSB config” may be used interchangeably.

A WTRU may be predefined and/or receive configuration info associated with reference signals/SSBs.

According to an embodiment, the WTRU may be predefined and/or receive configuration information, and/or sub-configurations (e.g. subset of parameters associated with a configuration) associated with reference signals (RS). Such RSs (e.g. applicable in DL) may include any of the following (a-f):
a) First SSB (SSB-a):
   a1) Signals: light sync signals (e.g. one or two sync signals that may use limited sequence length and/or resources) and a first PBCH type, which may be referred to herein as a “light” PBCH (e.g. contains a small payload);
a2) Periodicity: periodicity of the SSB-a is shorter relative to the periodicity of SSB-b (e.g. periodicity of SSB-a is 20ms);
a3) TD properties: may be located on even/odd SFNs, first/second half-frame index, set of OFDM symbols in a slot/subframe;
a 4) FD properties: on/off sync raster (e.g. 5G/6G bands, perched carriers), may or may not overlap in FD with SSB-b (e.g. located on same/different carriers than SSB-b);
a5) SD/beam properties: wide beams (typical) and narrow beams (e.g. same beam indexes as SSB-b beams, same QCL assumption as SSB-b beams);
a6) Type: always-on periodic (e.g. for coverage), semi-persistent, on-demand (NW-triggered, WTRU triggered);
a7) Usage: assist IDLE mode (camping, T/F sync, access SSB-b/SI), CONN mode (e.g. for L1 measurements, mobility, RLM/BM).
b) second SSB (SSB-b):
b1) Signals: one or two sync signals (e.g. PSS/SSS, sync signals that may use longer sequence length and/or resources), second PBCH type which may contain a larger PBCH payload, PBCH-DMRS, MIB, SIB1, SI;
b2) Periodicity: longer relative to the periodicity of SSB-a (e.g. the periodicity of SSB-b is >=160 ms);
b3) TD properties: may be in any SFN/half-frame/subframe/slot (for flexibility;
b 4) FD properties: on/off sync raster (e.g. 5G/6G bands, perched carriers, anchor carriers): Different SSB-b configs on different carriers may overlap/aligned in TD, and in some deployments (e.g. small cell), SSB-b on different carriers may not overlap in TD.
b5) SD/beam properties: Narrow beams (typical) and wide beams;
b6) Transmission type: always-on (for coverage), on-demand (NW-triggered, WTRU triggered);
b7) Usage: IDLE mode (sync, camping, RACH) and CONN mode (L1/L3 RRM measurements).
b8) New RS/SSBs that may include additional/lower set of resources/signals/parameters than those in legacy SSBs, including a combination of PSS/SSS, MIB, PBCH, pre-SIB1, SIB1, RACH config, UL WUS config, PUCCH resource config, SDT resources, SRS resources, etc.
c) Legacy NR/5G SSB:
c1) Cell defining SSBs (CD-SSB) or non-cell defining SSBs (NCD-SSBs);
c2) Frequency locations of the SSBs may be on and off sync raster (e.g. GSCN, ARFCN or other sync raster).
d) Measurement RS: e.g. SSB-a, SSB-b, DMRS, CSI-RS, TRS, PTRS.
e) NES-RS, including:
e1) On-demand SSBs (OD-SSBs) that may be available in a certain duration/window with certain periodicity/inter-burst gap, from a reference/start time onwards;
e2) WTRU/group-specific RS (e.g. a set of RS beams that may be triggered/transmitted for a WTRU/WTRU group).
f) light-RS: RS that may contain a combination of one or more sync signals, PSS, SSS, discovery reference signal (DRS), PBCH only, SIB1 only.

Such configuration for RS (RS config) may be applicable for supporting one or more NES adaptations in different any of time, frequency, spatial and power domains, for example. Such configurations/parameters may be applicable for any of the embodiments described herein. In examples described herein, the terms “NES-RS”, “Enhanced RS”, “measurement RS” and “light RS” may be used interchangeably when referring to any reference signals that may or may not be identical to the legacy SSBs. Additionally, the term “SSB/RS config” may apply to any of SSB-a and SSB-b configs. In the examples described herein, the terms “SSB-a”, “SSB-a signals” and “SSB-a transmissions” may be used interchangeably, to refer to any of the signals or transmissions associated with SSB-a. The same applies for SSB-b.

The configurations/sub-configurations associated with SSB/RS, at least in part, may be received in broadcast transmission (e.g. PBCH, MIB, SI, SIBx) or in dedicated RRC signaling (e.g. in RRCReconfiguration message) during CONNECTED mode or in INACTIVE/IDLE mode (e.g. RRCRelease message, when transitioning from CONNECTED mode to INACTIVE mode, or in PCBH, paging DCI in IDLE mode). Alternatively, any of the configurations, sub-configurations and parameters may be received by the WTRU, at least in part, in one or more dynamic signaling indications (e.g. in MAC CE or DCI) or in NES/cell activity indications, for example. Such NES/cell activity indications may be received in RRC signaling, MAC CE, DCI (e.g. WTRU-specific or group common DCI) or PDSCH, for example. In an example, the WTRU may receive a first subset of parameters associated one or more RS configs in PBCH/MIB/SIBx/RRC signaling and a second subset of parameters or update to the parameters in the first subset may be received in dynamic signaling (e.g. MAC CE, DCI).

The WTRU may receive, in configuration info, one or more of the following parameters associated with the SSB/RS config or sub-configs (a-q):
a) Indexes/IDs of one or more SSB/RS configs (e.g. SSB-a config, SSB-b configs), SSB/RS resource sets or resources;
b) SSB/RS resources, such as time-domain resources, frequency domain resources, spatial domain resources, each of which are discussed hereinafter.

Time domain resources: Number of symbols per slot (e.g. 1, 2, 4 symbols per slot), start offset symbol, repetition factor, burst periodicity, duration/window of RS transmission, time gap between beams/RS/bursts, comb/interleaving pattern. When the RS configs correspond to an SSB transmission config/pattern, the config/pattern may indicate the candidate locations of the SSBs in SSB bursts in terms of any of the following parameters: SFN index (e.g. even or odd indexes), half-frame index (e.g. first or second half of a frame), subframe, slot, symbol.

Frequency domain resources: Number of PRBs, center frequency, start offset PRB (e.g. from a reference location), repetition factor, comb pattern, raster location (e.g. on GSCN, ARFCN, carrier) whether resources are on/off sync raster. In examples, a subset of SSB/RS (e.g. SSB-a) may be transmitted on a carrier (e.g. perched carrier that may be located on sync raster), that may be different than the carrier (e.g. anchor carrier) where other subsets of SSB/RS (e.g. SSB-b) may be located. For example, WTRU in IDLE mode may locate SSB-a on the perched carrier (e.g. for sync) and relocate to SSB-b on the anchor carrier (e.g. for initial access).

Spatial domain resources: Number of RS/beams in a burst, position of RS in a burst (e.g. bitmap), beamwidth of RS beams (e.g. wide-beams, narrow beams).

Each RS config/sub-config may include resources which may or may not overlap with the resources in other RS configs/sub-configs, for example.

In an example, the resources allocated for one or more RS configs/sub-configs may correspond to an RS resource pool.
c) SSB/RS ports: Number and set of Tx and/or Rx ports
d) Resource type: Corresponds to the time-domain behavior of RS resource config which may be periodic, semi-persistent, aperiodic or on-demand (e.g. NW-triggered, WTRU-triggered)
e) Active SSB/RS resources in a burst: For an SSB config, the parameter may indicate the SSB positions in a burst. The active SSBs in a burst (index of SSBs that are transmitted) may be indicated via bitmap with different lengths, e.g. bitmap length of 4 bits may be used for FR1 when there may be 4 SSBs in a burst. Bit “1” may indicate an SSB is active/transmitted and bit “0” may indicate the SSB is off.
f) Periodicity: For an SSB config, the parameter may indicate the periodicity of SSB bursts on a cell (e.g. 5 ms, 20 ms, 160ms).
g) Usage type: WTRU may be configured with any of:
synchronization, cell (re)selection, initial access, paging (e.g. for IDLE mode);
beam management, RLM, NES, codebook/non-codebook, antenna switching for using such RS (e.g. for CONN mode).
h) Slot level periodicity and slot level offset, e.g. for periodic or semi-persistent RS
i) SSB/RS resource/beam bandwidth
j) Frequency hopping info:

A WTRU may be configured with one or more hopping patterns that may be applied over a set of RS resources in any of the time, frequency, and spatial domains;

In a hopping pattern, the RS resources (e.g. for SSB-a, SSB-b) may be located in time and/or frequency location, where the resource may or may not overlap in time and frequency domains (e.g. SSB-b may be at frequency F1 and F2 in time T1, at frequency F1 at time T2, at frequence F1 and F2 at T3, . . . . );

In a hopping pattern, a partial set of RS resources in frequency domain (e.g. PRBs) may be used in each time domain resource (e.g. symbol) for transmitting/receiving the RS using different spatial relation. Such hopping pattern may correspond to one or more NES adaptation/state, for example.
k) Guard period:

Number of symbols/slots/ms;

A WTRU may apply the guard period when switching between different RS configs/sub-configs or when switching between different Rx ports for the RS reception.
l) SSB/RS comb pattern info:

A parameter may include transmission comb value, which may be associated with the gap in terms of the number of PRBs or number of symbols/slots between two RS resources in the frequency and/or time domains;

Each RS config may include one or more RS comb patterns, where each pattern may be associated different set of parameters (e.g. offset value, cyclic shift) and/or RS resources in time/frequency/spatial domains;

A comb pattern may include RS resource in different symbols (within one slot or across multiple slots) or slots, where the RS in different symbols/slots may be received with different spatial relation/filter;

When RS is configured with periodic or semi-persistent RS resources, the RS comb pattern (e.g. using resources in time, frequency, spatial domains) may be repeated in each period;

When RS is configured with aperiodic RS resources, the RS burst may consist of RS resources in time, frequency, spatial domains;
m) Comb offset hopping pattern with repetition
n) Sync signals:

The sequences used (e.g. m-sequence, Zadoff-Chu sequence) for the sync signals in SSB-a may be the same or different than the sequences in the sync signals of SSB-b;

In an example, the sequences used for sync signals in SSB-a may be of a different format (e.g. short format) than those in SSB-b (e.g. long format), e.g., possibly to enable fast synchronization;

The resources (e.g. in terms of number of subcarriers and/or symbols) used for the sync signals in SSB-a may be lower/higher compared to the resources used for the sync signals in SSB-b.
o) Beam Tx power: may include the Tx power applied per RS signal/resource/beam/burst (e.g. SS-PBCH-Block power)
p) Power control parameters: may include any of alpha, p, pathloss reference RS, power per RB block, and RS power control adjustment states (e.g. closed loop factor) q) Reference beam:

Index/ID of an SSB/RS beam (e.g. SSB, CSI-RS, TRS) that may be predefined, preconfigured or indicated to serve as a reference beam, possibly for determining any of the power offset/adjustment and RSRP/RSRQ/pathloss thresholds;

A set of SSB/RS beams (e.g. in a burst, period, pool, config, cell) may be associated with at least one reference beam;

A reference beam may be configured to located within an SSB burst (e.g. one SSB out of K SSBs in a burst) or may be outside of a burst (e.g. separate signal outside of an SSB burst);

In an example, the reference beam may be transmitted with a peak Tx power;

In an example, the reference beam may serve as a QCL source for the other associated beams.

The WTRU may receive, in configuration info, the following events, conditions and/or threshold values for selecting or using any of the SSB configs/sub-configs, and SSB resources (a-d):
a) Measurement threshold values:

The threshold values may correspond to any of EPRE, RSRP, RSRQ, SINR, CQI, pathloss, etc.;

For example, the WTRU may select an RS (e.g. an SSB-a beam as a pathloss RS), when the measurements made on an associated RS is higher/lower than a RSRP threshold;

The threshold values may be configured/indicated based on any of a per RS/beam, per burst, and per config/sub-config.
b) Timing info:

Start time threshold: For example, an RS resource/beam may be received if it begins no later than a start time of T1 symbols/slots/ms after the WTRU receives an indication associated with activation of the RS config to which the RS resource belongs;

End time threshold: For example, an RS resource/beam may be received if it ends no earlier than an end time of T2 symbols/slots/ms after the WTRU receives an indication associated with deactivation of the RS config to which the RS resource belongs;

Time window (e.g. start offset time, length): For example, the WTRU may use one or more RS configs that may be accommodated within the time window for RS transmission.
c) Transmission/reception power:

Tx power threshold: For example, the WTRU may use one or more RS resources (e.g. in time domain and/or frequency domain) if the receive power (e.g. total power in RS resources in a transmission instance) is less than a first power threshold value and/or greater than a second power threshold value;

Power spectral density (PSD) threshold: For example, the WTRU may use one or more RS resources (e.g. in time domain and/or frequency domain) if the PSD over the RS resources is less than a first PSD threshold value and/or greater than a second PSD threshold value.
d) Priority:

One or more priority values may be associated with any of RS configs, RS resources, and RS parameters;

For example, the WTRU may use an RS config, when the priority associated with the RS config is higher than a priority threshold value and/or lower than another priority threshold value.

Any of the configurations, parameters, and embodiments described in this section are applicable in other sections of this invention.

Example Configurations associated with cells in multi-cell deployments for NES

In one embodiment, the WTRU may receive configurations and/or sub-configurations associated with one or more cells in a multi-cell deployment. Such configuration info may include any of the following (a-b):
a) Config associated with a Coverage/Anchor Cell (Cell A):

Cell A may provide wider coverage (e.g. One or more NES cells may be overlaid over a Cell A);

Cell A may transmit both SSB-a (e.g. short periodicity) and always-on SSB-b (e.g. long periodicity). Additional SSB-a/SSB-b may be transmitted by Cell A on on-demand basis;

Any of the SSBs and/or NES-RS may be transmitted in wide beams (e.g. when operating is NES mode) or in narrow beams (e.g. during high load conditions);

WTRU may receive the UL-WUS config for one or more NES Cells or Cell A in any of the RS (e.g. SSB-a) of Cell A.
b) Config associated with an NES cell:

NES Cell may provide limited coverage (e.g. optimized for capacity and energy savings);

NES Cell may transmit SSB-a with short/long/adaptable periodicity both as always-on RS or as on-demand RS;

NES Cell may transmit SSB-b with long periodicity (typical) as always-on RS or as on-demand RS;

NES Cell may transmit sync signals, light PBCH, SSB-a to support time/frequency synchronization, cell measurements, cell (re)selection, paging, initial access, etc., possibly for IDLE mode operation;

NES Cell may transmit sync signal (e.g. SSB-a), NES-RS (e.g. OD-SSB), SSB-b, measurement RS (e.g. CSI-RS) to support time/frequency synchronization, RRM, RLM/BM, etc., possibly for CONN mode operation;

WTRU may receive the SSBs/RSs in or out of sync raster. For example, WTRU may receive the SSBs on ARFCN channels that may be known to WTRU or dynamically indicated to WTRU;

WTRU may send an UL WUS signal to NES cell for requesting SSB-b/NES-RS/SIBx, possibly in scenarios when such RS/beams are not transmitted for transmitted with long periodicity.

Throughout the embodiments described in this disclosure, the terms “NES Cell” and “small/capacity/micro cell” may be used interchangeably. Also, the terms “Coverage cell”, “Anchor Cell” and “Cell A” may be used interchangeably.

### Determining the Location of SSB-a and SSB-b in Time/Frequency Domains

According to embodiments, a WTRU may determine the locations of SSB-a and SSB-b signals in time/frequency domains based on predefined/preconfigured information and information in contained the SSBs. The WTRU may receive one or more SSB-a signals from a cell. The WTRU may not receive the always-on SSB-b signals or may receive SSB-b signals with long periodicity from such cell, possibly operating in an energy savings mode/state. WTRU may be predefined or preconfigured with any of SSB-a configurations (e.g. first sync signal and a first PBCH), SSB-b configurations (e.g. second and possibly a third sync signal, second PBCH, MIB) and association information between SSB-a and SSB-b. For example, such association info may be related to the properties (e.g. time/frequency locations, beams, periodicity) and/or inter-relationship between SSB-a and SSB-b signals. WTRU may determine the time/frequency locations for receiving SSB-b based on the first PBCH received in SSB-a and the predefined association info between the SSBs.

A WTRU may be predefined and/or configured with parameters associated with SSBs.

In the embodiments described herein, the WTRU may be predefined and/or receive configuration info from NW associated with the SSB-a and SSB-b transmitted by one or more cells. Such predefinition or configuration info may be received, entirely or one or more parts, in any of L3/RRC signalling (e.g. broadcast/SIB or dedicated signals), L2/MAC signaling (e.g. MAC CE) or L1/PDCCH (e.g. DCI, wake-up signalling) indications. Such information may include any of the combination of one or more of the following (a-h):
a) Set of SSB signals
a1) WTRU may be predefined/configured with one or more SSB signals (e.g. SSB-a, SSB-b) that may be grouped into one or more sets. Such set may refer to any of a burst, period, cycle and config/sub-config.
a2) The parameters associated with SSBs (e.g. SSB-a, SSB-b) may include any of:

Ids/Index(es) of a set of SSBs in a burst, number of SSBs in a burst, position of SSB beams in burst (e.g. a bitmap may indicate which of the beams that are active/inactive in a burst);

Sequences (e.g. id/index associated with sequence, format of sequence, time/frequency resources), which may be used for any of sync signals and PBCH DMRS of the SSB;

Resources in any of time, frequency, spatial domains;

Timing info, including any of start offset, start/end symbol for set of SSBs, time duration/window during which SSBs are transmitted, time gap between a set of one or more SSBs within and across bursts.
a3) In an example, WTRU may be configured with a first set of SSBs that may not be adapted (e.g. periodicity is not adapted, Tx power is constant) and a second set of SSBs that may be subject adaptation (e.g. adaptation of periodicity, adaptation of frequency location, adaptation of Tx power).
a4) In examples, a set of SSBs may be associated with common properties or characteristics. Such common properties of the SSBs may include any of:
time domain property (e.g. SSBs in a set are transmitted within an SFN and/or half-frame in a SSB burst, SSBs in a burst are transmitted with the same periodicity);

frequency domain (e.g. SSBs in a set are transmitted within a min-max range of subcarriers and/or resource elements in a carrier);
spatial domain property (e.g. number of beams in a burst per frequency range, share common QCL source, common QCL type);
power domain property (e.g. Tx power of SSBs in a set is within a max-min power range), resource type (e.g. periodic, semi-persistent, aperiodic, on-demand).
a5) For example, when any of the property/association for at least one of the SSBs in a set is changed/adapted, a similar change/adaptation may apply for one or more of the other SSBs in the set.
b) Parameters associated with one or more SSB-a configs
b1) WTRU may be predefined/configured with the following parameters associated with SSB-a:

Index/ID (e.g. index per SSB-a config);
periodicity of SSB-a (e.g. periodicity per set, per burst or per signal/beam);
periodicity of a subset of SSB-a signals containing first PBCH (e.g. periodicity per burst or per signal/beam);
reference SFN (e.g. SFN#0 per SSB-a config);
frequency location (e.g. location of start/center frequency of the RBs associated with SSB-a on/off sync raster);

Cell index/ID (e.g. the PCI of the cell transmitting SSB-a may be encoded/scrambled/included in any of the sequences or signals transmitted by the cell including first sync signals, first PBCH, PBCH DMRS);

Sequence used in the RS resources associated with SSB-a (e.g. m-sequence, Zadoff-Chu sequence);

Tx power of SSB-a signals/beams/resources (e.g. indexes to one or more power levels, power offset values with respect to a reference/max/min power levels).
b2) SSB-a may include at least a sync signal (e.g. first sync signal). The first sync signal may be different from those in SSB-b (e.g. format, limited sequence length, limited resources), e.g. possibly to enable fast measurements related to synchronization. The first sync signals may be scrambled with one or more scrambling sequences. For example, the first sync signal in an SSB-a received in a first time period (e.g. SFN#1) may be scrambled with a first scrambling sequence and the first sync signal in an SSB-a received in a second time period (e.g. SFN#3) may be scrambled with a second scrambling sequence. Such scrambling sequences may be associated with the SFN values in which the SSB-a may be transmitted, for example.
b3) In some examples, SSB-a may correspond to low power synchronization signals (LP-SS), that may be received by the WTRU in a low power receiver. The WTRU may wake up the main radio in WTRU when detecting SSB-a with the LP receiver, for example.
b4) SSB-a signals may not be typically transmitted in all SFNs, subframes or slots but may be transmitted in a subset of SFNs/subframes (e.g. SFNs with even or odd index values).
b5) At least a subset of SSB-a signals (e.g. in some time/frequency locations) may include a first PBCH. The first PBCH may consist of a PBCH DMRS (e.g. sequence) and payload. In examples, for a set of SSB-a signals transmitted with periodicity P1, a subset of SSB-a signals containing light PBCH (e.g. PBCH DMRS and payload) may be transmitted with P2 (e.g. P2>P1). The first PBCH (e.g. DMRS associated with first PBCH) may be scrambled with one or more scrambling sequences. For example, the first PBCH in an SSB-a received in a first time period (e.g. SFN #1) may be scrambled with a first scrambling sequence and the first PBCH in an SSB-a received in a second time period (e.g. SFN #3) may be scrambled with a second scrambling sequence. Such scrambling sequences may be associated with the SFN values in which the SSB-a may be transmitted, for example.
b6) The first PBCH may be referred to herein as light PCBH and may contain less information then a second PBCH. The term “light PBCH” is for example purposes only. Any two PBCHs transmitted or received that carry different information may be used and still be consistent with the examples of the embodiments described herein.
b7) WTRU may be configured with one or more SSB-a configs, where each config may be associated with different index/ID and properties in any of time domain (e.g. periodicity, start offset, reference SFN), frequency domain (e.g. location on sync raster, carrier, offset from a reference frequency location), spatial domain (e.g. number of SSB-a beams of burst) and power domain (e.g. Tx power per SSB-a signal/beam).
b8) One or more of the SSB-a configs may be associated with always-on SSB-a transmissions (e.g. periodic SSB-a transmissions with a fixed periodicity) and other SSB-a configs may be associated with on-demand SSB-a transmissions (e.g. semi-persistent or aperiodic SSB-a transmissions over a time window).
c) Parameters associated with one or more SSB-b configs
c1) WTRU may be predefined/configured with the following parameters associated with SSB-b:

Index/ID (e.g. index per SSB-b config);
periodicity of SSB-b (e.g. periodicity per set, per burst or per signal/beam);
periodicity of a subset of SSB-a signals containing second PBCH (e.g. periodicity per set per burst or per signal/beam);

reference SFN (e.g. SFN#0 per SSB-b config);
frequency location (e.g. location of start/center frequency of the RBs associated with SSB-b on/off sync raster);

Cell index/ID (e.g. the PCI of the cell transmitting SSB-b may be encoded/scrambled/included in any of the sequences or signals transmitted by the cell including second/third sync signals, second PBCH, PBCH DMRS);

Sequence used in the RS resources associated with SSB-b (e.g. m-sequence, Zadoff-Chu sequence);

Tx power of SSB-b signals/beams/resources (e.g. indexes to one or more power levels, power offset values with respect to a reference/max/min power levels).
c2) SSB-b signals may include any of one or more sync signals (e.g. second and third sync signals, PSS/SSS), a MIB, PBCH (e.g. DMRS, payload). The second/third sync signals may be scrambled with one or more scrambling sequences. For example, the second/third sync signal in an SSB-b received in a first time period (e.g. SFN#1) may be scrambled with a first scrambling sequence and the second/third sync signal in an SSB-a received in a second time period (e.g. SFN#3) may be scrambled with a second scrambling sequence.
c3) At least a subset of SSB-b signals may have system information (e.g. SIB1) that may be transmitted or received with the SSB-a signals or in other associated signals/channels (e.g. PDCCH/PDSCH).
c4) At least a subset of SSB-b signals (e.g. in some time/frequency locations) may include a second PBCH. The second PBCH may consist of a PBCH DMRS (e.g. sequence) and a payload. In examples, the payload may contain and/or may be associated with other signals/channels containing one or more SI, including any of cell selection info, RACH config, serving cell config. In examples, for a set of SSB-b signals transmitted with periodicity P3, the subset of SSB-b signals that may be associated with SI#a and SI#b may be transmitted with periodicity P4 and P5, respectively (e.g. P4>P3, P5>P3).
c5) The second PBCH (e.g. DMRS associated with the second PBCH) may be scrambled with one or more scrambling sequences. For example, the second PBCH in an SSB-b received in a first time period (e.g. SFN#1) may be scrambled with a first scrambling sequence and the second PBCH in an SSB-b received in a second time period (e.g. SFN#3) may be scrambled with a second scrambling sequence. Such scrambling sequences may be associated with the SFN values in which the SSB-a may be transmitted, for example.
c6) WTRU may be configured with one or more SSB-b configs, where each config may be associated with different index/ID and properties of SSB-a in any of time domain (e.g. periodicity, start offset, reference SFN), frequency domain (e.g. location on sync raster, carrier, offset from a reference frequency location), spatial domain (e.g. number of SSB-b beams of burst) and power domain (e.g. Tx power per SSB-b signal/beam).
c7) One or more of the SSB-b configs may be associated with always-on SSB-b transmissions (e.g. periodic SSB-b transmissions with a fixed periodicity) and other SSB-b configs may be associated with on-demand SSB-b transmissions (e.g. semi-persistent or aperiodic SSB-b transmissions over a time window).
d) Association information between SSB-a and SSB-b signals may include any of the following:
d1) Periodicity relation:

Periodicity of SSB-b transmissions may be associated with the periodicity of SSB-a transmissions based on a scaling factor y (e.g. y>=1);

When SSB-b contains or associated with a signal (e.g. second sync signal, MIB, second PBCH) or a particular SI (e.g. SIB1), the scaling factor may be adjusted as y*i, where i may be associated with the signal or the SI. In this case, different SI may be associated with different i value, for example;

In examples, the periodicity of SSB-b transmissions may be associated with other properties of SSB-a based on different scaling factor values, including those associated with the TD/FD resources of SSB-a (e.g. number of symbols, number of RBs), scrambling sequence used in the first sync signal or first PBCH of SSB-a (e.g. index of sequence), and time/frequency offset of SSB-a (e.g. relative to a reference point). For example, periodicity of SSB-b may be determined based on the index of scrambling sequence used for scrambling the first sync signal of SSB-a and an associated scaling factor value.
d2) Control resource set associated with SSB-a/SSB-b:

WTRU may be predefined/configured with one or more control resource sets (CORESETs) or PDCCH monitoring configs where the control indications associated with any of SSB-a and SSB-b may be received;

For example, the WTRU may switch between a first CORESET/PDCCH monitoring configuration associated with an SSB-a config and a second CORESET/PDCCH monitoring configuration associated with an SSB-b config, possibly for receiving any control indications (e.g. DCI) associated with SSB-a and SSB-b signals.
d3) Periodicity of a search space (SS):

Periodicity of a search space (e.g., indicated by a PDCCH configuration in a MIB included in an SSB-b transmission) for receiving PDCCH associated with one or more SI (e.g., a target SI) may be associated with the periodicity of the SSB-a or the SSB-b transmissions, e.g., based on a scaling factor z;

In examples, periodicity of SS for receiving PDCCH associated with each of one or more target SI (e.g. SI1, SI2) may be associated with a different scaling factor value (e.g. z1, z2);

For example, the scaling factor for the periodicity of SS for receiving PDCCH associated with SI1=z1, scaling factor for the periodicity of SS for receiving PDCCH associated with SI2 =z2.
d4) Multiplexing pattern: A multiplexing pattern may indicate N SSB-a transmissions may be followed by M SSB-b transmissions, possibly within a time window or period. Different multiplexing patterns may be associated with different properties of SSB-a and/or SSB-b (e.g. index, periodicity, etc.).
d5) Timing relation:

In examples, the timing relation between SSB-a and SSB-b may be indicate whether SSB-a and SSB-b signals are transmitted with the same or different pattern. For example, the association info may indicate both SSB-a and SSB-b are transmitted in either even or odd numbered SFNs. In this case, a subset of the even/odd SFNs that contain SSB-a may also contain SSB-b, for example;

A timing relation between SSB-a and SSB-b may be associated with a time offset. The time offset for SSB-b relative to SSB-a or a reference time point (e.g. in units of SFNs, subframes, symbols, ms) may be associated with properties of SSB-a based on different scaling factor values, including those associated with the periodicity of SSB-a, TD/FD resources of SSB-a (e.g. number of symbols, number of RBs), scrambling code/sequence used in the first sync signal or first PBCH of SSB-a (e.g. index of sequence), and time/frequency offset of SSB-a (e.g. relative to a reference point);

For example, the time offset of an SSB-b signal (relative to an SSB-a signal) may be determined based on the periodicity of SSB-a and a time offset scaling value;

For example, the time offset of an SSB-b signal (relative to an SSB-a signal) may be determined based on the scrambling code/sequence used in the first PBCH of SSB-a. The scrambling code in first PBCH of SSB-a may indicate the number of time periods (e.g. SFNs) to the nearest SSB-b from the SSB-a;

In examples, timing relation info may be provided as a time offset/gap between the last symbol/slot of an SSB-a signal/beam in a burst and the first symbol/slot of the first of N SSB-b beams in a burst. For example, the timing of an SSB-a signal/beam (e.g. last symbol/slot of an SSB-a beam in a burst of an SSB-a config) may be T1 and the timing of the SSB-b beam (e.g. first symbol/slot of the first SSB-b beam in a burst of an SSB-b config) may be T2=T1+time offset.
d6) Frequency relation:

A frequency relation between SSB-a and SSB-b may be associated with a frequency offset. Frequency offset for SSB-b relative to SSB-a or a reference frequency location point (e.g. in units of subcarriers, carriers, resource elements, resource blocks, Hz) may be associated with properties of SSB-a based on different scaling factor values, including those associated with the periodicity of SSB-a, TD/FD resources of SSB-a (e.g. number of symbols, number of RBs), scrambling sequence used in the first sync signal or first PBCH of SSB-a (e.g. index of sequence), and time/frequency offset of SSB-a (e.g. relative to a reference point);

For example, the frequence offset of an SSB-b signal (relative to an SSB-a signal) may be determined based on the periodicity of SSB-a and a frequency offset scaling value.
d7) Spatial relation:

Spatial relation for SSB-b beams relative to SSB-a beams (e.g. in terms of number of beams per burst) may be associated with properties of SSB-a based on different scaling factor values, including those associated with the number of SSB-a beams in a burst, the periodicity of SSB-a, TD/FD resources of SSB-a (e.g. number of symbols, number of RBs), scrambling sequence used in the first sync signal or first PBCH of SSB-a (e.g. index of sequence), and time/frequency offset of SSB-a (e.g. relative to a reference point);

For example, the number of SSB-b beams in a burst may be determined based on the number of SSB-a beams in a burst and a beam number scaling factor b (e.g. b>=1);

In examples, one (wide beamwidth) SSB-a beam may be associated with N (narrow beamwidth) SSB-b beams;

QCL info between the beams in SSB-a and SSB-b may be provided as a mapping relation between an id/index of SSB-a beams and id/indexes of SSB-b beams: For example, an SSB-a beam with index i may be associated with a set of SSB-b beams with indexes {a, b, c, d, e}; In this case, the set of SSB-b beams {a, b, c, d, e} may fall within the beamwidth or coverage of SSB-a beam i and/or may be transmitted from the same/similar set of antenna elements/ports/panels at the cell; The WTRU may use the same/similar spatial relation (e.g. spatial Rx filter) for receiving both SSB-a beam i and any beams within the set of SSB-b beams {a, b, c, d, e}.
e) CORESET/SS config:
e1) The WTRU may be predefined/configured with one or more resources in any of time, frequency, spatial and code domains for receiving any of group-common, cell-common, or WTRU-dedicated indications from NW, possibly in PDCCH;
e2) Such resources may be associated with a CORESET and/or a search space (SS), which may be associated with an initial bandwidth part, which may be monitored by the WTRU with a certain configured periodicity and/or a duration;
e3) Such CORESET and/or SS may be associated with CORESET0 and/or SS0 (common search space), which may be used for receiving a common PDCCH from the network;
e4) Such CORESET and/or SS may be associated with one or more multiplexing patterns which may indicate how the monitoring resources in which a PDCCH may be received may be multiplexed with SSB-a signals (e.g. in TD/FD);
e5) The WTRU may be configured with one or more parameters associated with CORESET/SS config including index (e.g. index of WUS monitoring config), periodicity, and time/frequency resource offset (e.g. with respect to a reference point in time/frequency).
f) Application time/delay: The WTRU may be configured with one or more application time/delay values, which may indicate a time duration starting with the time instance (e.g. symbol/slot) from the reception of an indication indicating the start/triggering of the SSB-a/SSB-b signals/beams to the time instance when the SSB-a/SSB-b signals/beams are actually transmitted or received. In examples, the application time for SSB-a may be the same or different than those of SSB-b.
g) Validity info associated RS configs:

The WTRU may be configured with a validity info associated with the SSB-a and SSB-b configs. Such validity info may be associated with any of time and location attributes;

For example, a time validity may indicate the time duration (e.g. in terms of SFNs, symbols, slots) during which any of the SSB-a and SSB-b configs may be assumed to be valid. After the end/expiry of the time duration, the WTRU may assume the SSBs associated with the SSB-a and SSB-b configs are no longer available/valid;

In another example, a location validity may indicate the coverage area or location, possibly that associated with WTRU location and/or cell ID, in which any of the SSB-a and SSB-b configs may be assumed to be valid. Outside of the location validity, the WTRU may assume the SSBs associated with the SSB-a and SSB-b configs are no longer available/valid, for example.
h) NES states/modes:

The WTRU may be configured with association info between NES states/modes and the corresponding SSB-a and SSB-b configs. For example, when configured with cell DTX config, consisting of a set of periodically occurring active and non-active periods, the WTRU may assume SSB-a signals may be available during the cell DTX non-active periods or when cell DTX is deactivated, and the SSB-b signals may be available only during the cell DTX active periods. In another example, the WTRU may assume SSB-a signals may be available regardless of cell DTX periods and SSB-b signals may be available only during cell DTX active periods;

Alternatively, the SSB-a signals may be available in a first group of symbols/slots/periods associated with cell DTX and the SSB-b may be available in a second group of symbols/slots/periods associated with cell DTX, for example.

WTRU Receives SSB-a Signals from a Cell

In examples described herein, the WTRU may receive one or more signals of an SSB-a. Such SSB-a signals may be associated with an active SSB-a configuration. Such SSB-a signals may be received by WTRU during any of the following: power on, when supporting any functions associated with IDLE mode (e.g. cell (re)selection, synchronization, SI update, paging), and when supporting functions associated with CONNECTED mode (e.g. L1/L3 measurements, RLM, BM).

In typical scenarios, the WTRU may receive SSB-a signals before SSB-b signals. Such scenarios may be applicable when SSB-a signals may be transmitted or received more frequently than SSB-b (e.g. periodicity of SSB-b is longer than that of SSB-a). Another scenario is when SSB-a may be located in the frequency domain on the sync raster carriers or initial/start-up carriers (e.g. perched carriers), which may be preconfigured/predefined in the WTRU. The SSB-b may be located on a different carrier (e.g. anchor carrier) that may not be known to the WTRU in advance. In some scenarios, where both SSB-a and SSB-b may be located on the same carriers, the WTRU may receive at least one transmission of SSB-b, possibly before receiving SSB-a signals. In this case, the WTRU may achieve synchronization with one or more SSB-b signals without SSB-a signals, and perform other idle mode functions (e.g. cell selection, initial access) based on the MIB/SI received in association with SSB-b. Otherwise, the WTRU may first receive SSB-a signals (for synchronization and locating SSB-b signals) before receiving the MIB/SI in SSB-b signals.

The SSB-a signals received by WTRU may contain a first sync signal and a first PBCH (light PBCH). The first PBCH may consist of PBCH DMRS and payload (e.g. N1 bits). The WTRU may achieve synchronization with a cell transmitting SSB-a signals based on detection/reception of the first sync signals in one or more SSB-a signals.

The first PBCH in an SSB-a signal (e.g. first PBCH payload) may indicate any of the following:
a) SFN, e.g. n bits for indicating the SFN value where SSB-a is located;
b) Indication of SSB-a config:

Such indication (e.g. indicating ids/indexes) may be associated with any of the one of more of predefined/preconfigured SSB-a configs that may be active;

For example, different SSB-a configs may be associated with different sets of parameters (e.g. periodicity, number of beams in burst, etc.).
c) indication of always-on SSB-b config:

Such indication (e.g. indicating ids/indexes) may be associated with any of the one of more of predefined/preconfigured SSB-b configs;
e.g. indicates the always on SSB-b configs that may be associated with the SSB-a;

For example, different SSB-b configs may be associated with different sets of parameters (e.g. periodicity, number of beams in burst, etc.). The indication may indicate of at least one of the preconfigured SSB-b configs that may be active, for example.
d) association between SSB-a and SSB-b config: e.g. indicates an index/id of the association between SSB-a and SSB-b.
e) scaling factor value for the periodicity of an SSB-b: e.g. scaling factor may indicate the periodicity of SSB-b is 2x the periodicity of SSB-a.
f) scaling factor value for the periodicity of the SS for receiving PDCCH (e.g., configured in the PDCCH configuration in MIB of SSB-b) associated with receiving SI (e.g., a target SI):
E.g. Scaling factor value may indicate the periodicity of the SS (for receiving PDCCH) associated with an SI is 4x the reference periodicity which may be that of the SSB-a or SSB-b;
E.g. For M number of SI that may be included in SSB-b (e.g. different bitfields of MIB/PBCH payload of SSB-b) or in a signal/channel associated with SSB-b (e.g. PDCCH/PDSCH), the first PBCH may indicate M scaling factor values (explicitly or implicitly).
g) indication of CORESET/search space (SS) config:

May indicate an index/ID to a predefined/preconfigured configuration/resources associated with CORESET and/or search space (e.g. CORESET0 or SS0);

Such CORESET/SS config may be associated with a common set of resources (e.g. in any of time, frequency, spatial and code domains) which the WTRU may monitor for receiving any or group-common, cell-common or WTRU-dedicated indications (e.g. DCI), possibly in PDCCH;

Such CORESET/SS config may be associated with one or more properties of SSB-a (e.g. index, periodicity, symbol duration, scrambling code in first PBCH), which may be used by the WTRU for determining the corresponding CORESET/SS config.
h) Indication of priority:

May indicate the priority value associated with one or more SSB-b configs;

In an example, when any of the SSB-b signals associated with different SSB-b configs overlap in any of time, frequency or spatial domains, the WTRU may use the indicated priority value for determining which of the SSB-b signals to be selected and/or used, e.g. for measurements, cell (re)selection, initial access, etc. In this case, the WTRU may select the SSB-b signals associated with the SSB-b config with the highest priority, for example.
i) time location of SSB-b:
E.g. may indicate the absolute time location (e.g. SFN) or a relative time location of an SSB-b (e.g. next/nearest SSB-b signal) in terms of a time offset relative to the time location of SSB-a or a reference time point. Such time offset may be indicated in units of SFNs, subframes, slots, symbols, and ms;

In an example, the time offset for SSB-b (e.g. time period, possibly in terms of SFNs, when SSB-b is transmitted relative to SSB-a) may be indicated by a scrambling code/sequence in the first PBCH of SSB-a, where the scrambling code/sequence may be associated with the time offset value.
j) frequency location of SSB-b: e.g. may indicate the absolute frequency location (e.g. carrier) or a relative frequency location of an SSB-b (e.g. next/nearest SSB-b signal) in terms of a frequency offset relative to the frequency location of SSB-a (e.g. center frequency) or a reference time point (e.g. point A). Such frequency offset may be indicated in units of subcarriers, carriers, resource elements, resource blocks.
k) Tx power parameters:
E.g. may indicate at least one of predefined/preconfigured Tx power values used for SSB-a and/or SSB-b signals. Such Tx power may be used by WTRU for pathloss estimation and/or for determining the Tx power for any UL transmissions (e.g. PRACH);

In an example, the Tx power for SSB-b may be indicated as an offset or scaling value that may be applied to the Tx power of SSB-a or a reference power value (e.g. max Tx power). In this case, the WTRU may determine the Tx power of SSB-b based on the Tx power of SSB-b and the corresponding power offset value, for example;

Other parameters that may be indicated in first PBCH may include p0 and alpha value, which may be associated with power control.
1) Indication on activation/deactivation of SSB-b configs:

Such indication (e.g. indicating ids/indexes) may be associated with any of the one of more SSB-b configs. For example, different SSB-b configs may be associated with different sets of parameters (e.g. periodicity, number of beams in burst, etc.). The indication may indicate at least one of the preconfigured SSB-b configs that may be active/non-active, for example;

Such indication may be associated with any of periodic, semi-persistent, aperiodic or on-demand SSB-b configs;

Such indication on (de)activation of SSB-b configs may be received in a bitmap format, possibly with a certain configured length corresponding to the number of configured SSB-b configs, where the bit “1” in the bitmap may indicate the activation of an SSB-b config and bit “0” may indicate deactivation of an SSB-b config;

When receiving an activation indication, the WTRU may assume the SSB-b signals/beams associated with the SSB-b configs are usable. The WTRU may assume the info/resources in the activated SSB-b configs may be used immediately, after certain application time (e.g. configured/indicated) or after receiving another triggering indication, for example;

When receiving a deactivation indication, the WTRU may assume the info/resources in the deactivated SSB-b configs may be unused immediately, or after certain application time (e.g. configured/indicated), for example;

In examples, the indication may include info on new or updated parameters associated with the SSB-b configs. For example, the indication may indicate a set of new parameters (e.g. in time, frequency, spatial domain) for one or more SSB-b configs.
m) Signalling indicating the activation/deactivation of NES adaptations/states:
m1) Such indication may indicate the NES adaptation schemes (e.g. ids/indexes) such as SD/PD adaptations and cell DTX/DRX, based on which the WTRU may determine/identify the associated SSB-b configs. for example;
m2) In an example, the indication may include the timing info (e.g. in terms of absolute time symbols/slots/ms or relative time with respect to reference symbols/slots/ms) indicating when the NES adaptation is expected to start/end.

The WTRU may be preconfigured with one or more sets of parameters/indications that may be included in different first PBCH formats. For example, a first set of parameters (e.g. {SFN, scaling value of periodicity}) may be included in one first PBCH format and second set of parameters (e.g. {time location of SSB-b, frequency location of SSB-b}) may be included in another first PBCH format. Since different set of parameters may be included in different first PBCH formats each may contain different number of bitfields and different bitfield lengths. The different first PBCH formats may be associated with different index values. In an example, the first PBCH in SSB-a may include the index value associated with the first PBCH format based on which the WTRU may determine the bitfields (e.g. number of bitfields, length of each bitfield) and the associated parameters.

For minimizing the payload size of the first PBCH, only a subset of the parameters in the first PBCH may be provided explicitly. The remaining subset of parameters may be derived by WTRU implicitly based on a combination of limited number of bits in the first PBCH and other parameters that may be predefined/preconfigured (e.g. in the association info). In another example, a subset of the parameters may be implicitly indicated based on scrambling codes that may be used to scramble one or more bitfields associated with the parameters indicated in the first PBCH. For example, the scaling factor or the SFN where SSB-a may be located may be indicated based on a scrambling code, where there may be K different codes in a codebook (for indicating K possible SFN values) with each code may be of a fixed length. In this case, the SFN of SSB-a may be indicated by using an associated scrambling code and scrambling one or more parameters in the first PBCH of the SSB-a, for example. Upon receiving the first PBCH, the WTRU may determine the SFN of SSB-a by unscrambling the associated parameters in first PBCH using a suitable scrambling code.

In an example, the WTRU may not receive the absolute SFN value of SSB-a in the first PBCH but the SFN of SSB-a (e.g. SFN#x) may be determined and/or used in relative terms for determining the candidate time locations of SSB-b (e.g. SFN of SSB-b=SFN#x+time offset). Alternatively, the SFN of SSB-a may be determined based on one or more bits/signals/sequences included with those associated with SSB-a such as the first sync signal and first PCBH-DMRS. Alternatively, the SFN of SSB-a may be determined based on the scrambling sequence (index) that may be used for scrambling any of the first sync signal, first PBCH-DMRS and the first PBCH payload.

In an example, the WTRU may not receive the scaling factor for periodicity and may determine the periodicity of SSB-b relative to the periodicity of SSB-a based on the predefined scaling factor (e.g. periodicity of SSB-b is 4x periodicity of SSB-a). The WTRU may determine the periodicity of SSB-b or the index of a corresponding SSB-b config based on the SSB-a periodicity (e.g. by monitoring SSB-a signals in at least 2 occasions/periods) and the association info between the SSB-a periodicity and the SSB-b periodicity or the SSB-b config index.

In an example, the WTRU may determine the candidate time locations of SSB-b (e.g. in terms of SFNs) within a window based on a detection of a bit in the first PBCH of SSB-a in one or more SFNs where SSB-a signals are received and the predefined association info, indicating the presence of the bit in first PBCH and the presence of SSB-b within the window. For example, when the first PBCH of SSB-a received in one or more SFNs contains a bit (e.g. in a bitfield), the WTRU may assume that at least one SSB-b signal may be transmitted in one or more of the SFNs (in a window).

A similar approach may be applied for determining the time offset and/or frequency offset of SSB-b based on some bits in the first PBCH and the association info between properties of SSB-a and SSB-b. For example, the WTRU may use one or more bits indicated in the first PBCH (in a bitfield) and derive the time/frequency offset based on the bit value and the association between periodicity of SSB-a and the bit value.

### [WTRU Determines the Time/Frequency Locations of SSB-a and SSB-b]

In an example, the WTRU may determine the time locations of SSB-a based on predefined/preconfigured information and the information in or associated with the first PBCH of the SSB-a signals. For example, the WTRU may determine the SFN of one or more SSB-a signals based on an indication corresponding to the SFN (e.g. x bits) in the first PBCH. In some examples, a same value may be indicated and/or repeated in a bitfield of the first PBCH corresponding to the SFN of SSB-a for a certain number of repetitions or a cycle duration. In this case, the WTRU may determine the SFN of the SSB-a based on monitoring of the SSB-a signals for a certain period (e.g. 1 repetition cycle), possibly until a change or increment in the value is detected. In another example, the WTRU may determine the SFN of SSB-a based on a scrambling code that may be used for scrambling any of the first sync signal, DMRS of first PBCH and the first PBCH payload. For example, for a set of K scrambling codes (e.g. K may be associated with the periodicity of SSB-a and/or the scaling factor of the periodicity of SSB-b), the WTRU may determine the SFN of SSB-a based on the index of the scrambling code and the association between the K SFNs and K indexes of the scrambling codes.

In an example, the WTRU may determine the candidate time and/or frequency locations of the SSB-b signals based on the predefined/preconfigured information and the information in or associated with the first PBCH of the SSB-a signals. For determining the candidate T/F locations (e.g. the SFNs and the carriers where SSB-b signals may be transmitted) the WTRU may initially determine the periodicity of SSB-a and SSB-b. The WTRU may determine the periodicity of the SSB-a based on the indication on SSB-a config provided in the first PBCH of SSB-a and/or based on monitoring of the SSB-a signals in at least 2 occasions. The WTRU may then determine the periodicity of the SSB-b (e.g. containing the MIB/SI) based on periodicity of the SSB-a and the scaling factor (e.g. 2x) indicated in the first PBCH. For example, if the periodicity of the SSB-a is determined to be 20 ms and the scaling factor indicated by the first PBCH is 8, then the WTRU may determine the periodicity of the SSB-b to be 160 ms.

In an example, the WTRU may determine which period (e.g. same or subsequent period) of the SSB-a transmission includes a transmission of the SSB-b based on the reception of an SSB-a in a first period. In this case, the period may correspond to any of the SFN, time window, and cycle, for example. The first PBCH of the SSB-a may include a value indicating in which period (e.g. SFN) relative to the period of the SSB-a transmission includes a transmission of the SSB-b. For example, a value of 3 may indicate the SSB-b transmission occurs 3 SSB-a time periods (e.g. 3 SFNs) after the period in which the SSB-a is received. The WTRU may determine the period in which SSB-b is expected to be received based on a scrambling code/sequence. For example, the first PBCH of the SSB-a may be scrambled with a scrambling code/sequence that may indicate a value associated with when the SSB-b is transmitted or received relative to the SSB-a transmission. The first PBCH of different SSB-a transmissions may be scrambled with different scrambling codes for indicating different values corresponding to the distances between the SSB-a transmission and the SSB-b transmission.

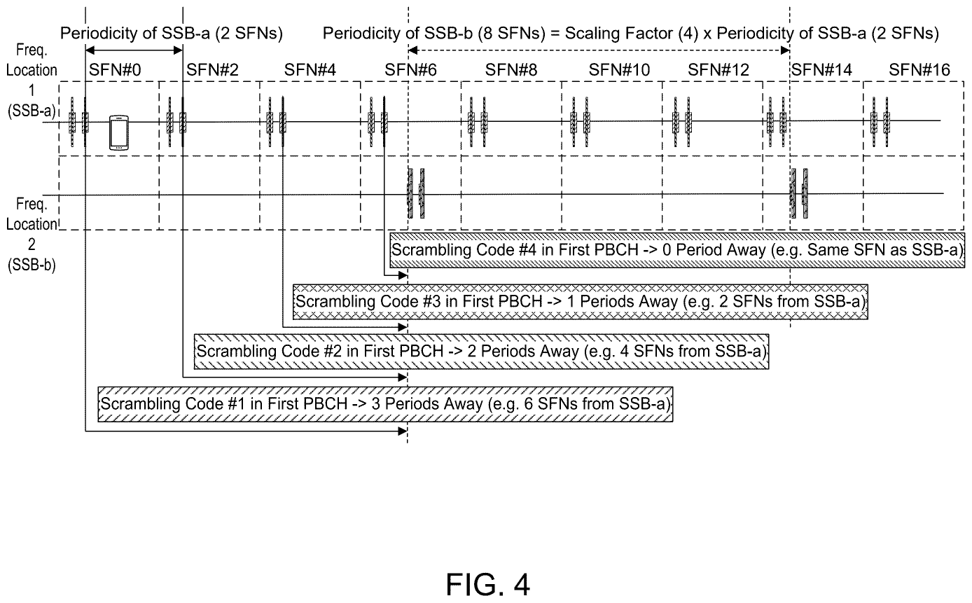

FIG. 4 shows the association between the periodicity of SSB-a and periodicity of SSB-b based on the scaling factor. In the example shown in the figure, the periodicity of SSB-b (e.g. 1 SSB-b every 8 SFNs) equals the scaling factor (4) multiplied by the periodicity of SSB-a (e.g. 1SSB-a in every 2 SFNs). The figure also shows the scrambling codes (e.g. code {1, 2, 3, 4}) used for scrambling the first PBCH of SSB-a, where each scrambling code indicates the distance (e.g. in terms of time periods) from the SFN of SSB-a to the nearest SFN where an SSB-b is located. In the example shown in the figure, scrambling code #2 is used to scramble the first PBCH of SSB-a located in SFN#2 for indicating 2 periods to the nearest SFN (i.e. SFN#6) where SSB-b is located.

In an example, the WTRU may determine candidate time locations of SSB-b signals relative to the time location of an SSB-a signal based on the time location of at least one SSB-a signal (e.g. in SFN#x) associated with an SSB-b config, the time offset of SSB-b (indicated in first PBCH), reference SFN of SSB-b (predefined/preconfigured) , and the periodicity of SSB-b (e.g. derived from periodicity of SSB-a and associated scaling factor). The WTRU may use a modulo function to initially determine the candidate locations of SSB-b signals (e.g. in terms of SFN indexes) starting from the reference SFN (e.g. SFN#0) and as a function of the SSB-b periodicity. The time locations of SSB-b signals relative to an SSB-a signal (e.g. next/nearest SSB-b signal from the SSB-a signal) may then be determined based on the SFN of the SSB-a and the initially determined candidate locations. For example, for an SSB-b periodicity of 8 SFNs (160ms), the initially determined candidate locations of SSB-b may correspond to {SFN#6, SFN#14, SFN#22, . . . }. Then based on determination of SFN of SSB-a (e.g. SFN#7), the WTRU may determine the time location of the nearest SSB-b to be at SFN190 14.

In an example, the WTRU may determine the candidate time locations of SSB-b signals (relative to the time location of SSB-a) associated with a signal/channel carrying the target SI (e.g. SIBx) based on the time location of SSB-a, time offset of SSB-b (e.g. indicated in first PBCH), reference SFN of SSB-b, periodicity of SSB-b associated with the target SI (e.g. derived from periodicity of SSB-a, periodicity of SSB-b and the scaling factor associated with the periodicity of the target SI). For example, WTRU may determine the SSB-b containing the target SI to be located in one of every 16 SFNs starting from the SFN of SSB-a based on the periodicity of the SSB-a (e.g. one in every 2 SFNs) and the scaled periodicity of SSB-b (e.g. periodicity of SSB-b containing SI#b is scaled by 8 the periodicity of SSB-a).

In an example, the WTRU may determine candidate frequency locations of SSB-b signals based on the frequency location of SSB-a signal (e.g. center frequency of resource blocks of SSB-a) and frequency offset of SSB-b that may be indicated in the first PBCH of SSB-a. In this case, the WTRU may first determine the frequency location of SSB-a (e.g. on a carrier) based on the predefined/preconfigured info and calculate the frequency location of SSB-b based on the offset value indicated in first PBCH.

A WTRU may receive SSB-b signals from a cell.

In examples described herein, the WTRU may receive one or more signals of SSB-b (e.g. signals containing second/third sync signals, second PBCH, MIB/SI). Such SSB-b signals may be associated with at least one active SSB-b configuration. Such SSB-b signals may be received by WTRU when supporting any functions associated with IDLE mode (e.g. cell (re)selection, synchronization, SI update, paging) and/or CONNECTED mode (e.g. L1/L3 measurements, RLM, BM).

In an example, upon determining the time and/or frequency locations of SSB-b signals, possibly based on the information provided via SSB-a signals, the WTRU may start monitoring at least the nearest determined candidate time/frequency locations from the last received SSB-a signal (e.g. next candidate SFN from the SFN of last SSB-a) for receiving the SSB-b signals. The received SSB-s signals may be used for any of measurements, cell (re)selection, paging, initial access, etc. The WTRU may receive the SSB-b signals containing MIB and/or the common SS config for receiving PDCCH associated with a target SI (e.g. cell selection info, RACH config). Such PDCCH (e.g. DCI encoded with a SI-RNTI) may indicate the PDSCH in which the target SI may be received.

In an example, the WTRU may determine the periodicity of the SS for receiving PDCCH for a target SI (e.g. SIBx, possibly for cell selection, initial access) based on the periodicity of the SSB-a and the associated scaling factor indicated in the first PBCH or in the PBCH of the SSB-b. The WTRU may receive the PDCCH associated with the target SI in the SS according to the determined periodicity of the SS. Upon receiving the target SI (e.g. in PDSCH) the WTRU may select the cell and/or transmit an indication to the cell using the resources indicated in the target SI. Such indication transmitted by the WTRU may include a PRACH preamble which may be transmitted in the resources (e.g. RACH occasions in time and/or frequency domain) which may be associated with one or more properties of SSB-a and/or SSB-b signals (e.g. periodicity, time/frequency location), for example.

### Determining the Location of SSB-a and SSB-b in Spatial Domain

According to embodiments, a WTRU may determine the locations of SSB-a and SSB-b signals in spatial domain based on predefined/preconfigured information and information in contained the SSBs. WTRU may be predefined or preconfigured with any of a set of wide beams in an SSB-a configuration (e.g. includes first sync signal and a first PBCH), a set of narrow beams in an SSB-b configuration (e.g. second and possibly a third sync signal, second PBCH, MIB) and association information between SSB-a beams and SSB-b beams. WTRU may determine the spatial locations for receiving SSB-b narrow beams based on the first/light PBCH received in SSB-a wide beam and the predefined association info between the SSBs.

A WTRU may be predefined and/or configured with parameters associated with SSBs.

In the examples described herein, the WTRU may be predefined and/or receive configuration info from NW associated with the SSB-a and SSB-b transmitted by one or more cells. Such predefinition or configuration info may be the same as that described in the previous section of this disclosure. Additionally, the WTRU may be predefined/preconfigured with the following info related to spatial domain:

Association information between SSB-a and SSB-b signals may include any of the following:
a) Association between a set of wide beams in SSB-a and narrow beams in SSB-2:

For example, the SSB-a wide beam {SSB-a #1} may be associated with an SSB-b narrow beam set consisting of {SSB-190 0, SSB-b #1, SSB-b#2, SSB-b#3};

For example, the SSB-a wide beam {SSB-a#2} may be associated with an SSB-b narrow beam set consisting of {SSB-b#4, SSB-b#5, SSB-b#6, SSB-b#7}.
b) Periodicity of SSB-b set of narrow beams may associated with the periodicity of SSB-a set of wide-beams based on a scaling factor:

For example, periodicity of the SSB-b narrow beam set {SSB-b#0, SSB-b#1, SSB-b#2, SSB-b#3} may be associated with the periodicity of SSB-a wide beam {SSB-a#1} based on a scaling factor y1;

For example, periodicity of the SSB-b narrow beam set {SSB-b#4, SSB-b#5, SSB-b#6, SSB-b#7} may be associated with the periodicity of SSB-a wide beam {SSB-a#2} based on a scaling factor y2.

A WTRU may receive SSB-a beams from a cell.

In examples described herein, the WTRU may receive one or more wide beams associated with an SSB-a config. Such SSB-a beams may be received by WTRU during any of the following: power on, when supporting any functions associated with IDLE mode (e.g. cell (re)selection, synchronization, SI update, paging), and when supporting functions associated with CONNECTED mode (e.g. L1/L3 measurements, RLM, BM).

The SSB-a signals received by WTRU may contain a first sync signal and a first PBCH (light PBCH). The first PBCH may consist of PBCH DMRS and payload (e.g. N1 bits). The WTRU may achieve synchronization with a cell transmitting SSB-a signals based on detection/reception of the first sync signals in one or more SSB-a signals.

From a set of one or more SSB-a wide beams, the WTRU may perform measurements (e.g. L1/L3 measurements) on the received beams and may select an SSB-a wide beam based on the measurements. For example, the WTRU may select an SSB-a wide beam based on the beam that has the highest RSRP.

In addition to the information in the previous section, the first PBCH in an SSB-a wide beam (e.g. first PBCH payload) may indicate any of the following (a-d):
a) A scaling factor value for the periodicity SSB-b narrow beams associated with periodicity of SSB-a wide beams:
E.g. scaling factor may indicate the periodicity of SSB-b narrow beams is 2x the periodicity of an SSB-a wide beam;
e.g. 2 bits may be used per SSB-a wide beam for indicating one of 4 possible scaling factor values for the periodicity of SSB-b narrow beams.
b) index of an SSB-b narrow beam (e.g. indicates the SSB-b beam index which may be associated with an SSB-b config)
c) index of an SSB-b config (e.g. indicates the SSB-b config associated with the SSB-a config);
d) association between SSB-a wide beam and SSB-b narrow beams, e.g. indicates an index/id of the association between SSB-a and SSB-b beams.

For minimizing the payload size of the first PBCH, only a subset of the parameters in the first PBCH may be provided explicitly. The remaining subset of parameters may be derived by WTRU implicitly based on a combination of limited number of bits in the first PBCH and other parameters that may be predefined/preconfigured (e.g. in the association info). In another example, a subset of the parameters may be implicitly indicated based on scrambling codes that may be used to scramble one or more bitfields associated with the parameters indicated in the first PBCH. For example, the index of SSB-a wide beam may be indicated based on a scrambling code, where there may be K different codes in a codebook (for indicating K possible beam indexes) with each code may be of a fixed length. In this case, the index of SSB-b beam may be indicated by using an associated scrambling code and scrambling one or more parameters in the first PBCH of the SSB-a, for example. Upon receiving the first PBCH, the WTRU may determine the index of SSB-a beam by unscrambling the associated parameters in first PBCH using a suitable scrambling code.

In another example, the index of SSB-a may be determined based on one or more bits/signals/sequences included with those associated with SSB-a such as the first sync signal and first PCBH-DMRS. Alternatively, the index of SSB-a may be determined based on the scrambling sequence (index) that may be used for scrambling any of the first sync signal, first PBCH-DMRS and the first PBCH payload.

In an example, the WTRU may determine the index of SSB-a beam based on any of the info in first PBCH (e.g. 2 bits for 4 SSB-a beam indexes), association info indicating association between beam location in time domain and beam index (e.g. symbol #z of a beam #k), combination of info in the first PBCH and predefined info.

In an example, the WTRU may determine the indexes of a set of SSB-b narrow beams based on index of SSB-a beam and the predefined/preconfigured association info between SSB-a and SSB-b beams.

In an example, the WTRU may not receive the scaling factor for periodicity and may determine the periodicity of SSB-b relative to the periodicity of SSB-a based on the predefined scaling factor (e.g. periodicity of SSB-b is 4x periodicity of SSB-a). The WTRU may determine the periodicity of SSB-b or the indexes of a corresponding SSB-b beams based on the SSB-a periodicity (e.g. by monitoring SSB-a signals in at least 2 occasions) and the association info between the SSB-a beam periodicity and the SSB-b periodicity or the index of the SSB-b beams.

A WTRU may determine the locations of SSB-b beams.

In an example, the WTRU may determine the time locations of a set of target SSB-b narrow beams based on info in the first PBCH of a selected SSB-a wide beam and the association info between the SSB-a wide beam and SSB-b narrow beams.

The WTRU may initially determine the time location of SSB-a based on predefined/preconfigured information and the information in or associated with the first PBCH of the SSB-a beam. For example, the WTRU may determine the SFN of the selected SSB-a beam based on an indication corresponding to the SFN (e.g. x bits) in the first PBCH or a scrambling code associated with the SFN that may be used in the first PBCH.

For determining the candidate time locations, the WTRU may also determine the periodicity of SSB-a and SSB-b. The WTRU may determine the periodicity of the SSB-a based on the indication on SSB-a config provided in the first PBCH of SSB-a and/or based on monitoring of the SSB-a beams in at least 2 occasions. The WTRU may then determine the periodicity of the SSB-b beams (e.g. containing the MIB/SI) based on periodicity of the SSB-a and the scaling factor (e.g. 2x) indicated in the first PBCH of SSB-a. For example, if the periodicity of the SSB-a beams is determined to be 20 ms and the scaling factor indicated by the first PBCH is 8, then the WTRU may determine the periodicity of the SSB-b beams to be 160 ms. In an example, the WTRU may determine the SSB-b narrow beams associated with an SSB-a beam to be located in one of every 8 SFNs starting from the SFN of SSB-a based on the periodicity of the SSB-a beam and the periodicity of SSB-b narrow beams (e.g. periodicity of SSB-b beams is scaled by 8 the periodicity of SSB-a wide beam).

In an example, the WTRU may determine in which period (e.g. same or subsequent period) of the SSB-a beam includes a transmission of the associated burst/set of SSB-b beams based on the reception of an SSB-a beam in a first period. In this case, the period may correspond to any of the SFN, time window, and cycle, for example. The first PBCH of the SSB-a may include a value indicating in which period (e.g. SFN) relative to the period of the SSB-a wide beam transmission includes a transmission of the burst/set of SSB-b narrow beams. For example, a value of 3 may indicate the SSB-b narrow beams occur 3 SSB-a time periods (e.g. 3 SFNs) after the period in which the SSB-a wide beam is received. The WTRU may determine the period in which SSB-b beams are expected to be received based on a scrambling code/sequence. For example, the first PBCH of the SSB-a wide beam may be scrambled with a scrambling code/sequence that may indicate a value associated with when the SSB-b beams are transmitted or received relative to the SSB-a beam. The first PBCH of different SSB-a beams may be scrambled with different scrambling codes for indicating different values corresponding to the distances between the SSB-a beam and the associated SSB-b beams. In this case, the scrambling codes used in the first PBCH of the one or more SSB-a beams may be different for indicating distances to the associated burst of SSB-b beams.

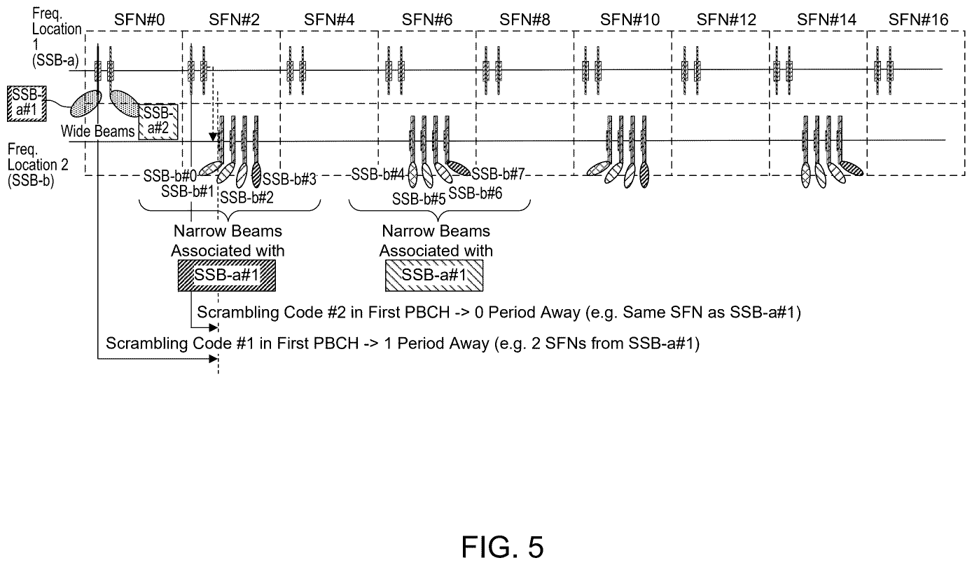

FIG. 5 shows the association between the SSB-a wide beams (e.g. SSB-a#1, SSB-b#2) and the SSB-b narrow beams (e.g. {SSB-b#0, SSB-b#1, SSB-b#2, SSB-b#3}, {SSB-b#4, SSB-b#5, SSB-b#6, SSB-b#7}). The figure also shows the association between periodicity of SSB-a beams and periodicity of SSB-b beams based on the scaling factor. In the example shown in the figure, the periodicity of SSB-b beams (e.g. one burst of SSB-b beams every 8 SFNs) equals the scaling factor (e.g. 4) multiplied by the periodicity of SSB-a (e.g. one burst of SSB-a beams in every 2 SFNs). The figure also shows the scrambling codes (e.g. code {1, 2}) used for scrambling the first PBCH of an SSB-a beam, where each scrambling code indicates the distance (e.g. in terms of time periods) from the SFN of the SSB-a beam to the nearest SFN where the associated burst of SSB-b beams are located. In the example shown in the figure, scrambling code #1 is used to scramble the first PBCH of SSB-a#1 beam located in SFN#0 for indicating 1 period (e.g. 2 SFNs) to the nearest SFN (i.e. SFN#2) where the associated burst of SSB-b beams are located.

In an example, the WTRU may determine candidate time locations of SSB-b beams (e.g. set/burst of SSB-b beams) relative to the time location of an SSB-a wide beam based on the time location of at least one SSB-a beam (e.g. in SFN #x) associated with an SSB-b beams, the time offset of SSB-b beams (indicated in first PBCH), reference SFN of SSB-b beams (predefined/preconfigured), and the periodicity of SSB-b beams (e.g. derived from periodicity of SSB-a and associated scaling factor). The WTRU may use a modulo function to initially determine the candidate locations of SSB-b beams (e.g. in terms of SFN indexes) starting from the reference SFN (e.g. SFN#0) and as a function of the SSB-b periodicity. The time locations of SSB-b beams relative to an SSB-a beam (e.g. next/nearest SSB-b beams from the SSB-a beam) may then be determined based on the SFN of the SSB-a and the initially determined candidate locations. For example, for an SSB-b beams periodicity of 8 SFNs (160ms), the initially determined candidate locations of SSB-b beams may correspond to {SFN#6, SFN#14, SFN#22, . . . }. Then based on determination of SFN of SSB-a beam (e.g. SFN#7), the WTRU may determine the time location of the nearest SSB-b beams to be at SFN#14.

WTRU Receives SSB-b Beams from a Cell

In examples described herein, the WTRU may receive one or more SSB-b beams (e.g. containing second/third sync signals, second PBCH, MIB/SI). Such SSB-b signals may be associated with at least one active SSB-n configuration. Such SSB-a beams may be received by WTRU when supporting any functions associated with IDLE mode (e.g. cell (re)selection, synchronization, SI update, paging) and/or CONNECTED mode (e.g. L1/L3 measurements, RLM, BM).

In an example, upon determining the locations of SSB-b beams, possibly based on the information provided via SSB-a beams, the WTRU may start monitoring at least the nearest determined candidate locations from the last received SSB-a beam (e.g. next candidate SFN from the SFN of last SSB-a) for receiving the SSB-b beams. The received SSB-b beams may be used for any of measurements, cell (re)selection, paging, initial access, etc.

From a set of one or more SSB-b narrow beams, the WTRU may perform measurements (e.g. L1/L3 measurements) on the received beams and may select a best SSB-b narrow beam based on the measurements. For example, the WTRU may select an SSB-b narrow beam based on the beam that has the highest RSRP. The WTRU may transmit an indication (e.g. PRACH preamble) to the cell using resources (e.g. RACH occasions in time and/or frequency domain) associated with a selected SSB-b beam.

A WTRU may be configured to perform measurements on SSB-a.

In an example, the WTRU may receive an indication on a first measurement config, where the measurement config may be associated with an SSB-a config. When in CONN mode, such indication may be received in any of L3/RRC, L2 or L1/DCI signaling. For a WTRU in IDLE mode, such indication may be received in SIBx, in a paging message (e.g. L1/DCI indication, paging early indication), initial access messages (e.g. Msg2, MsgB, Msg4) and WUS response message.

Such indication received by WTRU may indicate a request to perform measurements on SSB-a signals/beams, for example. Such indication may include the ids/indexes of one or more cells, id/index of at least one SSB-a config and possibly one or more RSRP threshold values. Upon receiving the indication, the WTRU may perform measurements on the SSB-a signals/beams received from the indicated cells. Such measurements, possibly on the wide beam SSB-a signals, may be associated with any of L3, L2 and/or L1 measurements. When performing measurements on SSB-a received from one or more cells, the WTRU may apply parameters associated with different spatial Rx filters, for example. During measurements, for example, if the WTRU detects both SSB-b and SSB-a beams (from the same or different cells), WTRU may prioritize measurements on the SSB-a signals/beams, possibly upon receiving the measurement config. In examples, the WTRU may identify one or more preferred SSB-a beams in the SSB-a config based on the measurements, where the preferred SSB-a beams may be those with RSRP above a threshold value.

The WTRU may send the measurement report or indication, possibly to the cell from which the WTRU received the first measurement config (e.g. serving cell or camping cell). The measurement report may include any of the ids/indexes of cells on which measurements are made, RSRP measurements of the sync signals/DMRS in SSB-a beams and ids/indexes of one or more preferred SSB-a beams. When in CONN mode, the WTRU may send the report/indication in any of RRC signaling, L2 (e.g. UL MAC CE) or L1 (e.g. UCI, PUCCH, PUSCH) signaling. When in IDLE mode, WTRU may send the report/indication, at least in part, in any of initial access messages (e.g. Msg1, MsgA, Msg3, Msg5), UL WUS resource/signal and common set of resources possibly accessed on contention basis. Such measurement reports/indication may indicate the suitability of cell switching or cell selection to another cell.

A WTRU may be configured to perform measurements on SSB-b.

In an example, the WTRU may receive an indication on a second measurement config, where the measurement config may be associated with an SSB-b config. When in CONN mode, such indication may be received in any of L3/RRC, L2 or L1/DCI signaling. For a WTRU in IDLE mode, such indication may be received in any of SIBx, paging message (e.g. L1/DCI indication), initial access messages (e.g. Msg2, MsgB, Msg4) and WUS response message. Such indication may indicate a request to perform measurements on the one or more SSB-b signals/beams in the SSB-b config, for example. Such indication may include the ids/indexes of at least one cell, id/index of at least one SSB-b config and id/index(es) of one or more SSB-b signals/beams in the SSB-b config (e.g. subset of beams). The indicated SSB-b signals/beams may be in the general direction where the WTRU may be located. Such SSB-b beams may be transmitted by the cell, possibly for a limited time duration (e.g. for energy savings) for the WTRU to perform enough measurements and possibly for cell switch/cell reselection to the associated cell, for example.

In an example, the WTRU may determine the spatial relation and/or timing info for performing measurements on the one or more SSB-b beams. Such spatial relation and timing info may be determined based on at least the second measurement config (e.g. associated with SSB-b config) and info on ids/index(es) of the SSB-b beams that may be indicated by the NW. For example, the WTRU may determine the spatial relation (e.g. parameters for spatial Rx filter) to apply for receiving the indicated SSB-b beams based on the spatial Rx filter applied for the SSB-a beams in the SSB-a config and the configured QCL/spatial relation info that associate both SSB-a and SSB-b configs. In this case, the association info (preconfigured/predefined in WTRU) may indicate the relation/mapping between the indexes of SSB-a signals/beams in an SSB-a config and indexes of SSB-b signals/beams in an SSB-b config). For example, when using spatial relation x for receiving a wide-beam SSB-a with index i, the WTRU may use the same spatial relation x for receiving any of the narrow-beam SSB-b beams with indexes {a, b, c, d, e}. For the timing info, the WTRU may determine the timing for receiving the indicated SSB-b beams based on the timing of the SSB-a beams and the configured association info on the timing relation.

The WTRU may perform measurements on the indicated SSB-b beams received from the indicated cells. Such measurements, possibly on the one or more narrow beams of SSB-b, may be associated with any of L3, L2 and/or L1 measurements. When performing measurements on the SSB-b beams, the WTRU may apply spatial relation (e.g. spatial Rx filters) that were applied when making measurements on the SSB-a beams that may be in QCL/spatial relation with the indicated SSB-b beams, for example.

The WTRU may send the measurement report or indication, possibly to the cell from which the WTRU received the second measurement config (e.g. serving cell or camping cell), including RSRP measurements of the SSB-b beams. When in CONN mode, the WTRU may send the report/indication in any of RRC signaling, L2 (e.g. UL MAC CE), and L1 (e.g. UCI, PUCCH, PUSCH) signaling. When in IDLE mode, WTRU may send the report/indication, at least in part, in any of initial access messages (e.g. Msg1, MsgA, Msg3, Msg5), UL WUS resource/signal and common set of resources possibly accessed on contention basis.

In examples, the WTRU may receive, in an indication, a command to perform cell-switch/handover/cell reselection to a cell (e.g. id/index of the cell). Such command (e.g. PRACH order) may include one or more PRACH preambles/resources for the WTRU to transmit when performing cell switch to the cell. Alternatively, the WTRU may use the PRACH preambles/resources received from the cell for performing UL transmission for cell switch/cell reselection. In some examples, the WTRU may receive conditions (e.g. L3/L1-RSRP measurement threshold values, time duration values) associated with one or more cells for the WTRU to perform conditional cell-switch/handover. In this case, for example, the WTRU may perform cell switch to a cell if any of the associated conditions for cell-switch/handover are met. Such indication (e.g. command for cell switch/cell reselection) may be received in any of L3/RRC, L2 or L1/DCI signaling when in CONN mode. Such indication may be received in any of SIBx, paging message (e.g. L1/DCI indication), initial access messages (e.g. Msg2, MsgB, Msg4) and WUS response message when in IDLE mode, for example.

The WTRU may perform cell switch/cell reselection to the indicated cell by transmitting any of a PRACH preamble or an UL indication (e.g. UL WUS signal, PUCCH/UCI/SR) using the provided resources. The WTRU may select a best SSB-b beam, possibly selected based on highest RSRP, for transmitting the PRACH preamble/UL indication associated with the selected cell.

A WTRU is predefined with SSB-a configurations (e.g. first sync signal and first PBCH), SSB-b configurations (e.g. second and possibly third sync signals, second PBCH, MIB) and association information between SSB-a and SSB-b. The WTRU determines the time/frequency locations for receiving SSB-b based on the first PBCH received in SSB-a and the predefined association info.

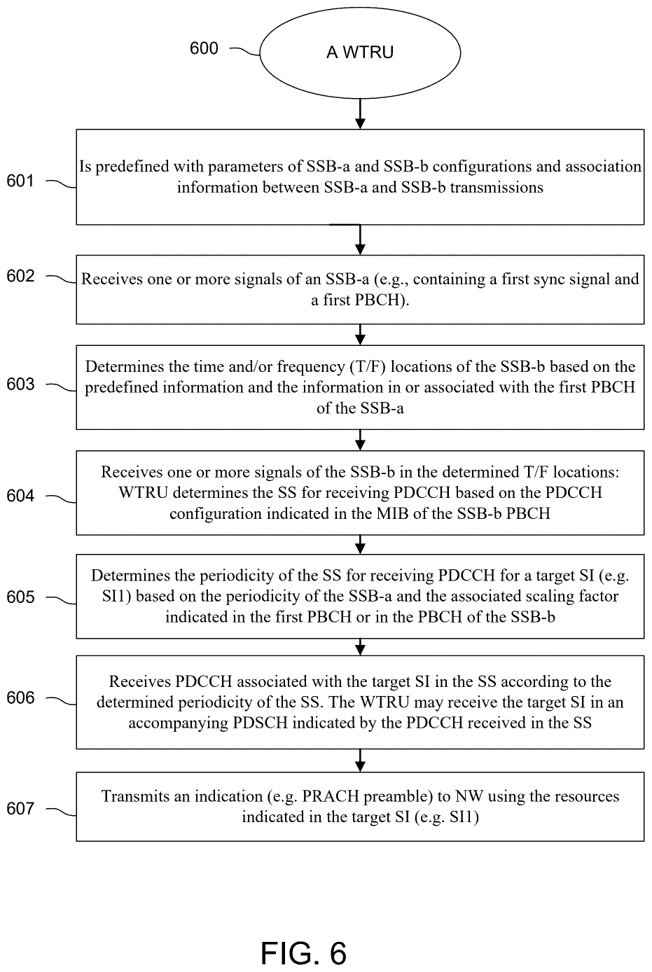

FIG. 6 is a flow-chart showing a method 600 for cell selection associated with a cell transmitting multiple SSB types and transmitting an indication to the cell using resources indicated in a target SI according to an embodiment, the method being implemented by a WTRU.

In 601, the WTRU is predefined with parameters of SSB-a and SSB-b configurations and association information between SSB-a and SSB-b transmissions. The association information may indicate any of the following:

Periodicity of SSB-b transmissions may be associated with the periodicity of SSB-a transmissions based on a scaling factor y (e.g. y>=1);

Periodicity of a search space (SS) (e.g., indicated by a PDCCH configuration in a MIB included in an SSB-b transmission) for receiving PDCCH associated with receiving SI (e.g., a target SI) may be associated with the periodicity of the SSB-a or the SSB-b transmissions, e.g., based on scaling factor z;
e.g. Periodicity of SS for receiving PDCCH associated with each of one or more target SI (e.g. SI1, SI2) may be associated with a different scaling factor value (e.g. z1, z2);
e.g. scaling factor for the periodicity of SS for receiving PDCCH associated with SI1=z1, scaling factor for the periodicity of SS for receiving PDCCH associated with SI2=z2.

In 602, the WTRU receives one or more signals of an SSB-a (e.g., containing a first sync signal and a first PBCH). The first PBCH may indicate any of the following:

A scaling factor for the periodicity of an SSB-b (e.g. an SSB-b containing the MIB);

A scaling factor for the periodicity of the SS for receiving PDCCH (e.g., configured in the PDCCH configuration in MIB of SSB-b) associated with receiving SI (e.g., a target SI).

In 603, the WTRU determines the time and/or frequency (T/F) locations of the SSB-b based on the predefined information and the information in or associated with the first PBCH of the SSB-a.
a) E.g. WTRU may determine the following:
periodicity of the SSB-a may be determined based on monitoring of the SSB-a signals in at least 2 occasions;
periodicity of the SSB-b (e.g. containing the MIB, SFN) may be determined based on periodicity of the SSB-a and the scaling factor (e.g. 2x) indicated in the first PBCH, e.g., if the periodicity of the SSB-a is determined to be 20 ms and the scaling factor indicated by the first PBCH is 8, then the WTRU may determine the periodicity of the SSB-b to be 160 ms.
b) E.g. Based on reception of an SSB-a in a first period, WTRU may determine which period (e.g. same or subsequent period) of the SSB-a transmission includes a transmission of the SSB-b:

The first PBCH of the SSB-a may include a value indicating which period relative to the period of the SSB-a transmission includes a transmission of the SSB-b: e.g. a value of 3 may indicate the SSB-b transmission occurs 3 SSB-a time periods after the period in which the SSB-a is received.

The first PBCH of the SSB-a may be scrambled with a scrambling code that indicates a value associated with when the SSB-b is transmitted relative to the SSB-a transmission.

In 604, the WTRU receives one or more signals of the SSB-b in the determined T/F locations: WTRU determines the SS for receiving PDCCH based on the PDCCH configuration indicated in the MIB of the SSB-b PBCH.

In 605, the WTRU determines the periodicity of the SS for receiving PDCCH for a target SI (e.g. SI1) based on the periodicity of the SSB-a and the associated scaling factor indicated in the first PBCH or in the PBCH of the SSB-b.

In 606, the WTRU receives PDCCH associated with the target SI in the SS according to the determined periodicity of the SS. The WTRU may receive the target SI in an accompanying PDSCH indicated by the PDCCH received in the SS.

In 607, the WTRU transmits an indication (e.g. PRACH preamble) to NW using the resources indicated in the target SI (e.g. SI1).

Amongst the benefits of the above method are, without being exhaustive:

Allows flexible transmission of SSBs (e.g. dense SSB-a and sparse SSB-b) for network energy savings;

Incurs low overhead for indicating the location of SSB-b based on info in SSB-a;

Incurs low latency and low processing at WTRU for determining the location of SSB-b (containing MIB/SI).

As used herein (i.e., throughout this application text), transmitting and/or receiving a channel should be considered as interchangeable with transmitting and/or receiving a channel transmission.

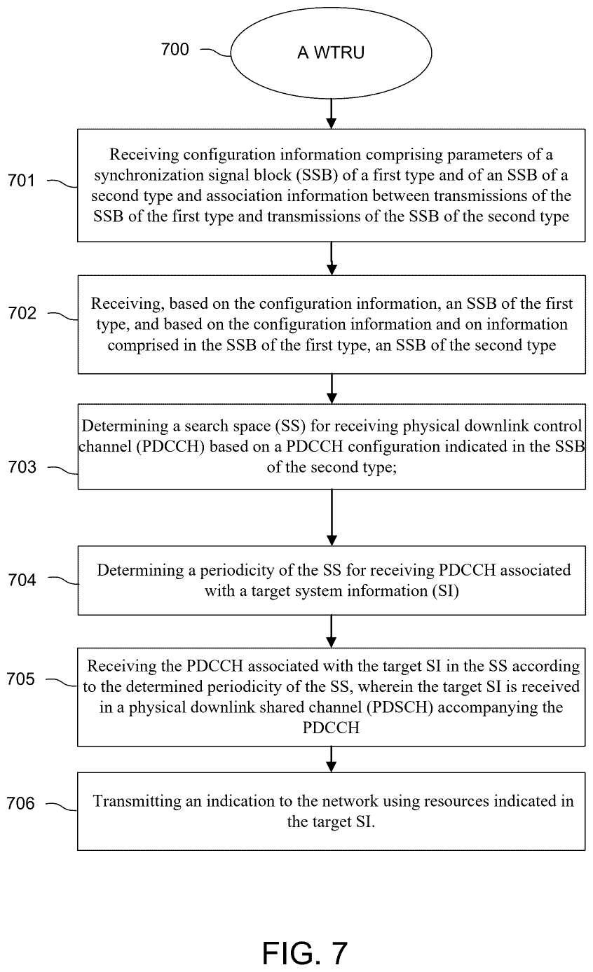

FIG. 7 is a flow-chart showing a method 700, implemented by a wireless transmit-receive unit (WTRU) in a network, for transmitting an indication (e.g., a PRACH preamble) to the network.

The method comprises, in 701, receiving configuration information comprising parameters of a synchronization signal block (SSB) of a first type and of an SSB of a second type and association information between one or more transmissions of the SSB of the first type and one or more transmissions of the SSB of the second type.

In 702, receiving, based on the configuration information, an SSB of the first type, and based on the configuration information and on information comprised in the SSB of the first type, an SSB of the second type.

In 703, determining a search space (SS) for receiving a physical downlink control channel (PDCCH) transmission based on a PDCCH configuration indicated in the SSB of the second type.

In 704, determining a periodicity of the SS for receiving a (e.g., the) PDCCH transmission associated with a target system information (SI).

In 705, receiving the PDCCH transmission associated with the target SI in the SS according to the determined periodicity of the SS, wherein the target SI is received in a physical downlink shared channel (PDSCH) transmission accompanying the PDCCH transmission.

In 706, transmitting an indication to the network using resources indicated in the target SI.

According to an embodiment, the SSB of the first type has a first periodicity of transmission and a first size, and the SSB of the second type has a second periodicity of transmission longer than the first periodicity of transmission and a second size greater than the first size.

According to an embodiment, the SSB of the first type comprises a first physical broadcast channel (PBCH) of a first type comprising a payload of a first PBCH payload size, and the SSB of the second type comprises a second PBCH of a second type comprising a payload of a second PBCH payload size, the second PBCH payload size being greater than the first PBCH payload size.

According to an embodiment, the first PBCH comprised in the SSB of the first type comprises information enabling to obtain the second periodicity of transmission of the SSB of the second type.

According to an embodiment, the information enabling to obtain the second periodicity of transmission of the SSB of the second type is a factor to be applied to the first periodicity of transmission of the SSB of the first type.

According to an embodiment, the first PBCH comprises information enabling to obtain the periodicity of the SS for receiving the PDCCH for the target SI.

According to an embodiment, the information enabling to obtain the periodicity of SS for receiving PDCCH for the target SI is a factor to be applied to the first periodicity of transmission of the SSB of the first type.

According to an embodiment, the first periodicity of transmission of the SSB of the first type is determined based on measuring a delay between at least two receptions of the SSB of the first type.

According to an embodiment, the indication transmitted to the network is a physical random access channel (PRACH) preamble.

There is also described and disclosed a WTRU in a network, the WTRU comprising at least one processor configured to:
receive configuration information comprising parameters of a synchronization signal block (SSB) of a first type and of an SSB of a second type and association information between transmissions of the SSB of the first type and transmissions of the SSB of the second type;
receive, based on the configuration information, an SSB of the first type, and based on the configuration information and on information comprised in the SSB of the first type, an SSB of the second type;
determine a search space (SS) for receiving physical downlink control channel (PDCCH) based on PDCCH configuration indicated in the SSB of the second type;

determine a periodicity of the SS for receiving PDCCH associated with a target system information (SI);
receive the PDCCH associated with the target SI in the SS according to the determined periodicity of the SS, wherein the target SI is received in a physical downlink shared channel (PDSCH) accompanying the PDCCH; and transmit an indication to the network using resources indicated in the target SI.

According to an embodiment of the WTRU, the SSB of the first type has a first periodicity of transmission and a first size, and the SSB of the second type has a second periodicity of transmission longer than the first periodicity of transmission and a second size greater than the first size.

According to an embodiment of the WTRU, the SSB of the first type comprises a first physical broadcast channel (PBCH) of a first type comprising a payload of a first PBCH payload size, and the SSB of the second type comprises a second PBCH of a second type comprising a payload of a second PBCH payload size, the second PBCH payload size being greater than the first PBCH payload size.

According to an embodiment of the WTRU, the first PBCH comprised in the SSB of the first type comprises information enabling to obtain the second periodicity of transmission of the SSB of the second type.

According to an embodiment of the WTRU, the information enabling to obtain the second periodicity of transmission of the SSB of the second type is a factor to be applied to the first periodicity of transmission of the SSB of the first type.

According to an embodiment of the WTRU, the first PBCH comprises information enabling to obtain the periodicity of SS for receiving the PDCCH for the target SI.

According to an embodiment of the WTRU, the information enabling to obtain the periodicity of SS for receiving PDCCH for the target SI is a factor to be applied to the first periodicity of transmission of the SSB of the first type.

According to an embodiment of the WTRU, the first periodicity of transmission of the SSB of the first type is determined based on measuring a delay between at least two receptions of the SSB of the first type.

According to an embodiment of the WTRU, the indication transmitted to the network is a physical random access channel (PRACH) preamble.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4,or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

1. A method, implemented by a wireless transmit-receive unit (WTRU) in a network, the method comprising:
receiving configuration information comprising parameters of a synchronization signal block (SSB) of a first type and of an SSB of a second type and association information between one or more transmissions of the SSB of the first type and one or more transmissions of the SSB of the second type;
receiving, based on the configuration information, an SSB of the first type, and based on the configuration information and on information comprised in the SSB of the first type, an SSB of the second type;
determining a search space (SS) for receiving a physical downlink control channel (PDCCH) transmission based on a PDCCH configuration indicated in the SSB of the second type;
determining a periodicity of the SS for receiving a PDCCH transmission associated with a target system information (SI);
receiving the PDCCH transmission associated with the target SI in the SS according to the determined periodicity of the SS, wherein the target SI is received in a physical downlink shared channel (PDSCH) transmission accompanying the PDCCH transmission; and
transmitting an indication to the network using resources indicated in the target SI.

2. The method of claim 1, wherein the SSB of the first type has a first periodicity of transmission and a first size, and the SSB of the second type has a second periodicity of transmission longer than the first periodicity of transmission and a second size greater than the first size.

3. The method of claim 2, wherein the SSB of the first type comprises a first physical broadcast channel (PBCH) of a first type comprising a payload of a first PBCH payload size, and the SSB of the second type comprises a second PBCH of a second type comprising a payload of a second PBCH payload size, the second PBCH payload size being greater than the first PBCH payload size.

4. The method of claim 3, wherein the first PBCH comprised in the SSB of the first type comprises information enabling to obtain the second periodicity of transmission of the SSB of the second type.

5. The method of claim 4, wherein the information enabling to obtain the second periodicity of transmission of the SSB of the second type is a factor to be applied to the first periodicity of transmission of the SSB of the first type.

6. The method of claim 3, wherein the first PBCH comprises information enabling to obtain the periodicity of the SS for receiving the PDCCH for the target SI.

7. The method of claim 6, wherein the information enabling to obtain the periodicity of SS for receiving a PDCCH transmission for the target SI is a factor to be applied to the first periodicity of transmission of the SSB of the first type.

8. The method of claim 2, wherein the first periodicity of transmission of the SSB of the first type is determined based on measuring a delay between at least two receptions of the SSB of the first type.

9. The method of claim 1, wherein the indication transmitted to the network is a physical random access channel (PRACH) preamble.

10. A wireless transmit-receive unit (WTRU) in a network, the WTRU comprising at least one processor configured to:
receive configuration information comprising parameters of a synchronization signal block (SSB) of a first type and of an SSB of a second type and association information between one or more transmissions of the SSB of the first type and one or more transmissions of the SSB of the second type;
receive, based on the configuration information, an SSB of the first type, and based on the configuration information and on information comprised in the SSB of the first type, an SSB of the second type;
determine a search space (SS) for receiving a physical downlink control channel (PDCCH) transmission based on PDCCH configuration indicated in the SSB of the second type;
determine a periodicity of the SS for receiving a PDCCH transmission associated with a target system information (SI);
receive the PDCCH transmission associated with the target SI in the SS according to the determined periodicity of the SS, wherein the target SI is received in a physical downlink shared channel (PDSCH) transmission accompanying the PDCCH transmission; and
transmit an indication to the network using resources indicated in the target SI.

11. The WTRU of claim 10, wherein the SSB of the first type has a first periodicity of transmission and a first size, and the SSB of the second type has a second periodicity of transmission longer than the first periodicity of transmission and a second size greater than the first size.

12. The WTRU of claim 11, wherein the SSB of the first type comprises a first physical broadcast channel (PBCH) of a first type comprising a payload of a first PBCH payload size, and the SSB of the second type comprises a second PBCH of a second type comprising a payload of a second PBCH payload size, the second PBCH payload size being greater than the first PBCH payload size.

13. The WTRU of claim 12, wherein the first PBCH comprised in the SSB of the first type comprises information enabling to obtain the second periodicity of transmission of the SSB of the second type.

14. The WTRU of claim 13, wherein the information enabling to obtain the second periodicity of transmission of the SSB of the second type is a factor to be applied to the first periodicity of transmission of the SSB of the first type.

15. The WTRU of claim 12, wherein the first PBCH comprises information enabling to obtain the periodicity of SS for receiving the PDCCH for the target SI.

16. The WTRU of claim 15, wherein the information enabling to obtain the periodicity of SS for receiving a PDCCH transmission for the target SI is a factor to be applied to the first periodicity of transmission of the SSB of the first type.

17. The WTRU of claim 11, to wherein the first periodicity of transmission of the SSB of the first type is determined based on measuring a delay between at least two receptions of the SSB of the first type.

18. The WTRU of claim 10, wherein the indication transmitted to the network is a physical random access channel (PRACH) preamble.
